(19) United States
(12) Patent Application Publication
(10) Pub. No.: US 2022/0300418 A1
(43) Pub. Date: Sep. 22, 2022

(54) MAXIMIZING RESOURCE BANDWIDTH WITH EFFICIENT TEMPORAL ARBITRATION

(71) Applicant: Intel Corporation, Santa Clara, CA (US)

(72) Inventor: Gary Baugh, Bray (IE)

(21) Appl. No.: 17/836,720

(22) Filed: Jun. 9, 2022

(51) Int. Cl. G06F 12/02

(52) U.S. Cl. CPC G06F 12/0284

(57) ABSTRACT

The present disclosure is discusses temporal access arbitration techniques for shared resources. Two separate address spaces may be defined for the shared resources and individual access agents. The temporal access arbitration techniques include temporally mapping addresses in an access agent address space to one or more addresses in the shared resource address space. The shared resources are accessed via linear addressing, where multiple addresses map to the same resources. Implementation constraints lead to a single resource being able to service several possible access agents per transaction cycle. In these ways, the temporal access arbitration techniques choreograph the access patterns of individual access agents so maximum resource bandwidth is achieved.

### TECHNICAL FIELD

The present disclosure is generally related to edge computing, cloud computing, data centers, hardware accelerators, and memory management, and memory arbitration, and in particular, to temporal access arbitration for shared compute resources.

### BACKGROUND

Shared memory systems typically include a block or section of memory (such as random access memory (RAM)) that can be accessed by multiple different entities (sometimes referred to as “memory clients” or “access agents”) such as individual processors in a multiprocessor computing system. Concurrent memory accesses to a share memory system by various memory clients is often handled at the memory controller level according to an arbitration policy. The choice of arbitration policy is usually based on memory client requirements, which may be diverse in terms of bandwidth and/or latency. However, existing memory arbitration schemes can introduce resource usage overhead.

Some existing memory arbitration techniques attempt to maximize the resource bandwidth by deliberately introducing gaps in the access address space. These gaps are introduced based on temporal access patterns, which are highly application dependent. In the case where the resource being accessed is a shared memory array, these gaps lead to a waste of limited resources. In some cases, some addresses will be mapped to unused data just to ensure the access agents are temporally out of phase, which can also increases resource overhead.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIGS. 1 and 2 depict an example compute tile architecture.

FIG. 3 depicts an example memory subsystem architecture.

FIG. 4 depicts an example memory block.

FIG. 5 example memory address scheme.

FIG. 6 depicts example access scenarios.

FIG. 7 depicts example linear address space configurations.

FIG. 8 depicts an example temporal access pattern.

FIGS. 9 and 10 depict example address translation for address staggering.

FIG. 11 depicts an example activation tensor.

FIG. 12a depicts an example processing unit architecture. FIG. 12b depicts an example input tensor.

FIGS. 13a and 13b depict examples address spaces for the activation tensor of FIG. 11. FIG. 13c depicts an example data storage element.

FIGS. 14 and 15 depict an example of swizzling address transformation.

FIGS. 16, 17, 18, 19, and 20 depicts example physical address spaces for the activation tensor of FIG. 11 based on different swizzle key parameters.

FIG. 21 illustrates an overview of an edge cloud configuration for edge computing.

FIG. 22 illustrates an example software distribution platform.

FIG. 23 depicts example components of a compute node.

FIG. 24 depicts an example infrastructure processing unit (IPU).

FIG. 25 depicts an example system capable of rebalancing of security control points.

FIG. 26 depicts an example neural network (NN).

FIG. 27 depicts an example temporal access arbitration process.

### DETAILED DESCRIPTION

The present disclosure is generally related to edge computing, cloud computing, data centers, hardware acceleration, and memory utilization techniques, and in particular, to temporal access arbitration for accessing shared resources such as memory resources shared among multiple processing elements (e.g., individual processors, processor cores, and/or the like).

### 1. Temporal Memory Access Arbitration Techniques

The present disclosure discusses mechanisms for efficiently providing temporal access to a finite set of shared resources (e.g., memory resources shared by multiple processors). The resource arbitration techniques discussed herein temporally map the agents (e.g., memory clients) to the shared resources so that maximum performance in terms of bandwidth usage is achieved. The shared resources are accessed via linear addressing, where multiple addresses map to the same resources. Implementation constraints lead to a single resource being able to service several possible access agents per transaction cycle. The present disclosure includes temporal access schemes for choreographing the access pattern of the access agents so maximum resource bandwidth is achieved. In various implementations, this is done by creating two separate address spaces for the shared resources and access agents as detailed infra.

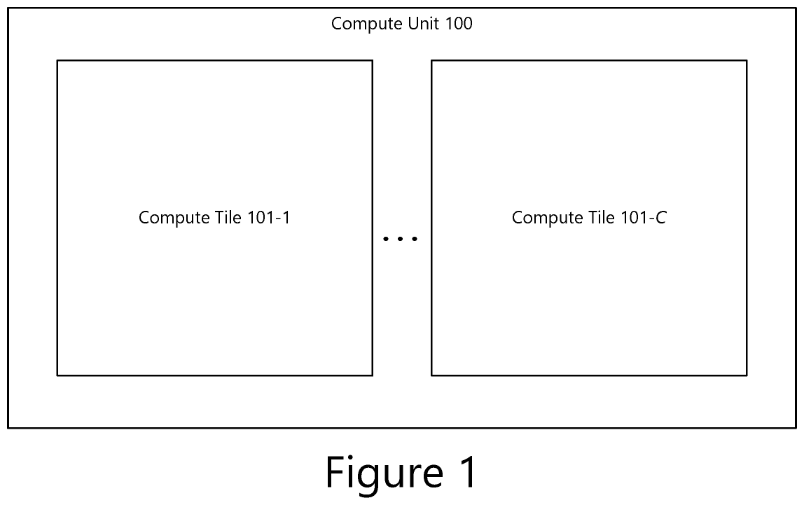

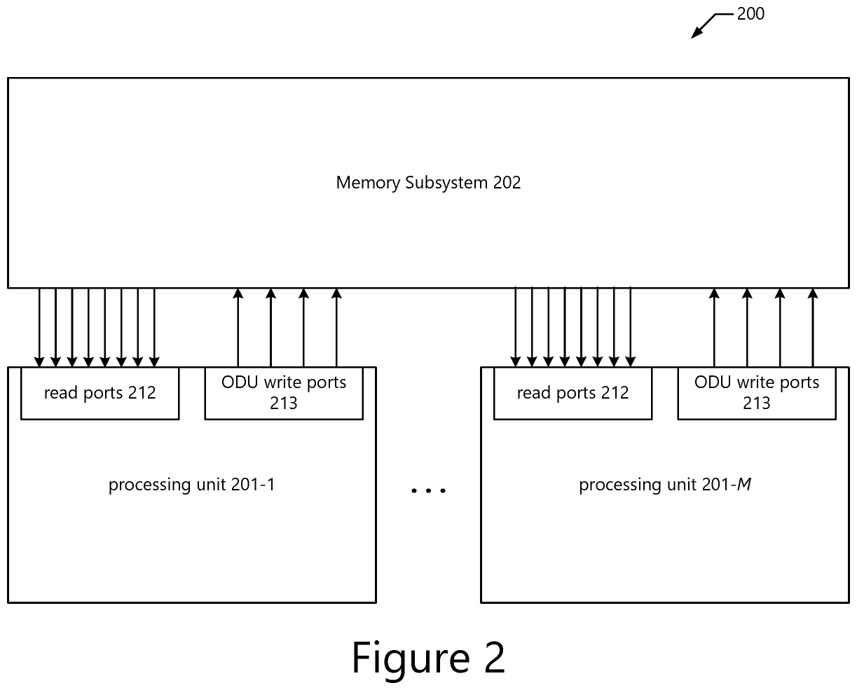

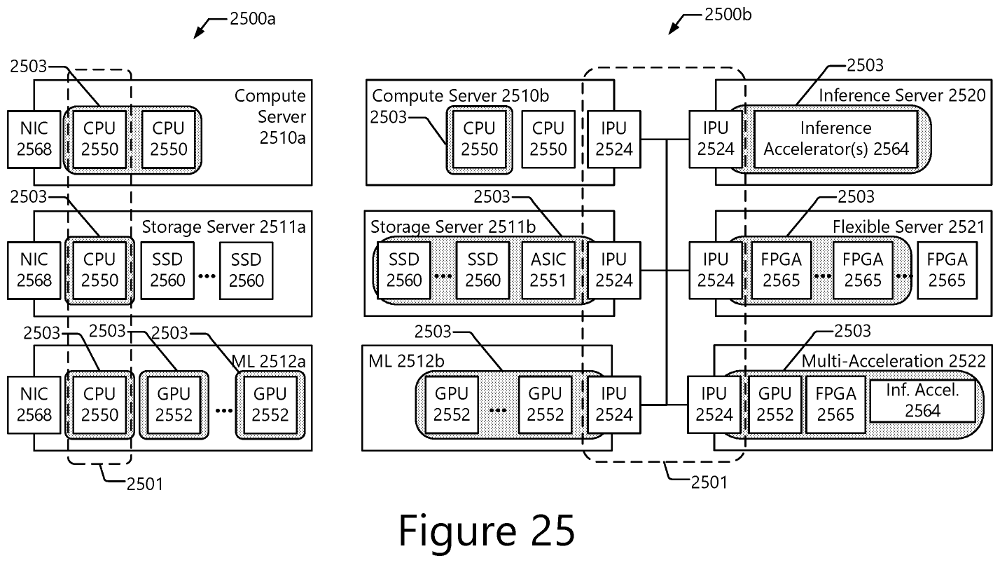

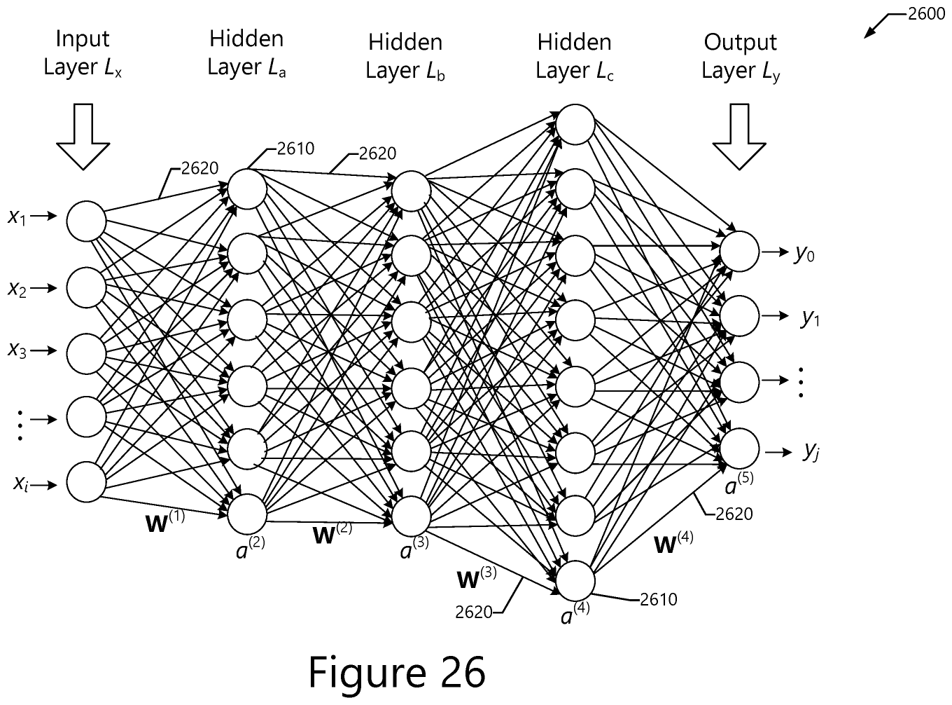

FIG. 1 depicts an example compute tile architecture. In particular, FIG. 1 shows an example compute unit 100 including 1-C compute tiles 101 (labeled as compute tile 101-1 to compute tile 101-C in FIG. 1, where C is a number of compute tiles 101). In some implementations, the compute unit 100 is a hardware (HW) accelerator, or a cluster or pool of HW accelerators that are connected to one another via a suitable fabric or interconnect technology, such as any of those discussed herein. Additionally or alternatively, one or more compute tiles 101 may be individual HW accelerators. Additionally or alternatively, at least one compute tile 101 is a vision processing unit (VPU) such as, for example, a VPU tile included in Intel® Movidius® sparse neural network accelerators. In other example implementations, the compute unit 100 can be a multiprocessor system, a multi-chip package (MCP), and/or an x-processing unit (XPU) and the compute tiles 101 may be individual processors of the multiprocessor system, MCP, or XPU. For example, a first compute tile 101 may be a CPU of an XPU 100, a second compute tile 101 may be a VPU of an XPU 100, a third compute tile 101 may be a GPU of an XPU 100, and so forth. In these implementations, each compute tile 101 may be any of the processing elements discussed herein, and an XPU may include any combination of such processing elements, an example of which is shown by FIG. 25 discussed infra. Additionally or alternatively, the compute unit 100 can be an embedded system such as a system-on-chip (SoC), and the compute tiles 101 may be individual processing elements in the embedded system/SoC. In any of the aforementioned implementations, the compute unit 100 and/or individual compute tiles 101 are configured to operate a suitable AI/ML model including one or more neural networks (NNs) such as the NN 2600 of FIG. 26 discussed infra. In various implementations, each compute tile 101 has an architecture as shown by FIG. 2.

FIG. 2 illustrates an example compute tile architecture 200, which may correspond to individual compute tiles 101 in FIG. 1. The compute tile architecture 200 includes 1-M processing units 201 (labeled as processing unit 201-1 to processing unit 201-M in FIG. 2, where M is a number), each of which is connected to a memory subsystem 202 via a set of read (input) ports 212 and a set of write (output) ports 213.

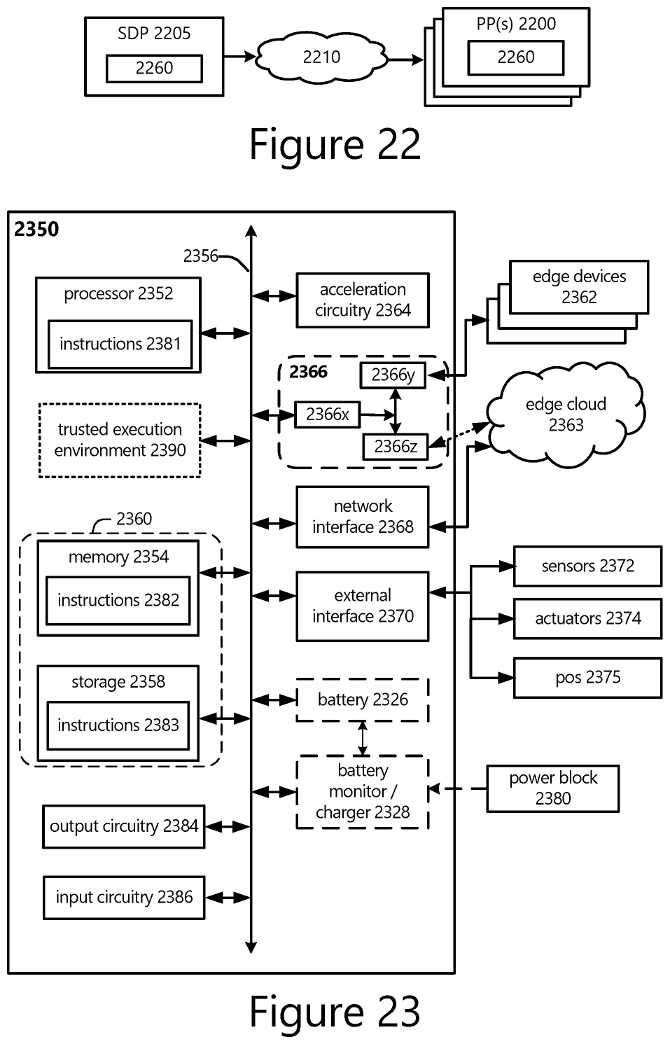

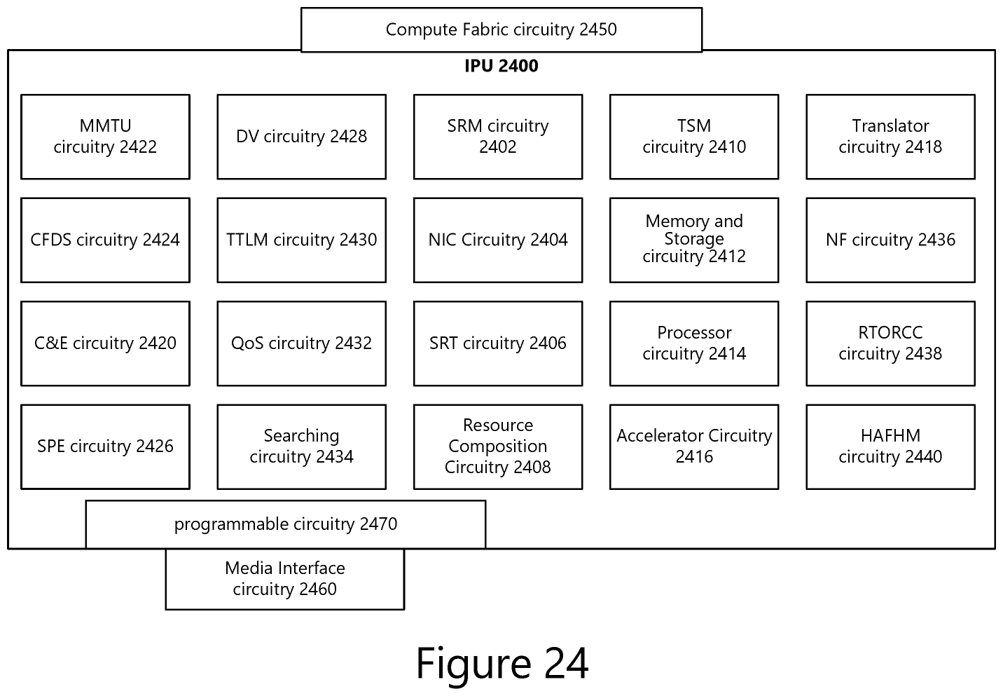

The memory subsystem 202 may be a high bandwidth memory subsystem, where the processing units 201 share access to the memory subsystem 202. The access pattern of memory subsystem 202 will likely affect the effective bandwidth of the memory subsystem 202 over time. As examples, the memory subsystem 202 can be embodied as one or more static random access memory (SRAM) devices, dynamic random access memory (DRAM) devices, and/or some other suitable memory devices such as any of those discussed herein. In some implementations, the memory subsystem 202 can be arranged into a set of slices (e.g., SRAM slices, DRAM slices, and/or the like) where each slice is connected to an individual processing unit 201. the memory subsystem 202 may be the same or similar as the memory circuitry 2354 and/or the storage circuitry 2358. Additionally or alternatively, the processing units 201 may be the same or similar as the processor circuitry 2352, 2414 and/or the acceleration/accelerator circuitry 2364, 2416 of FIGS. 23 and 24 discussed infra. In some implementations, the processing units 201 are channel controllers or other specialized programmable circuits used for hardware acceleration of data processing for data-centric computing. In some implementations, each processing unit 201 is a package, chip, or platform that includes processor circuitry, network interface circuitry, and programmable data acceleration engines. In one example implementation, the memory subsystem 202 is a Neural Network (NN) Connection Matrix (CMX) memory device in a NN accelerator. In another example implementation, the processing units 201 can be data processing units (DPUs), streaming hybrid architecture vector engine (SHAVE) processors, and/or some other special-purpose processors such as any of those discussed herein. In another example implementation, the processing units 201 can be general purpose processors such as any of those discussed herein In another example implementation, the read ports 212 can be input delivery unit (IDU) ports, and the write ports 213 are output delivery unit (ODU) ports. Additionally or alternatively, the compute tile architecture 200, or components thereof, can include other hardware elements other than those shown such as, for example, such as additional processor devices (e.g., CPUs, GPUs, and so forth) and/or additional memory devices (e.g., cache memory, DDR memory, and so forth). In some implementations, the memory can be shared among multiple different types of processing elements (e.g., CPUs, GPUs, IPUs, DPUs, XPUs, and so forth) in any arrangement. Additionally or alternatively, the processing units 201 can include multi-read memory (MRM) elements, a set of multiply-and-accumulate units (MACs), a set of post processing elements (PPEs), and/or the like. Any of the aforementioned example implementations can be combined in any suitable manner, including with any other example discussed herein.

In the example of FIG. 2, each processing unit 201 is connected to the memory subsystem 202 via eight (8) read ports 212 and four (4) write ports 213. This means that each processing unit 201 can write 8 units of data (e.g., bits, bytes, or the like) to the memory subsystem 202 at a time (e.g., per clock cycle or the like), and read 4 units of data (e.g., bits, bytes, or the like) from the memory subsystem 202 at a time (e.g., per clock cycle or the like). In some implementations, data is transmitted to and from individual processing units 201 as multiplexed packets of information. As discussed in more detail infra, the temporal access arbitration techniques can be used for the memory subsystem 202.

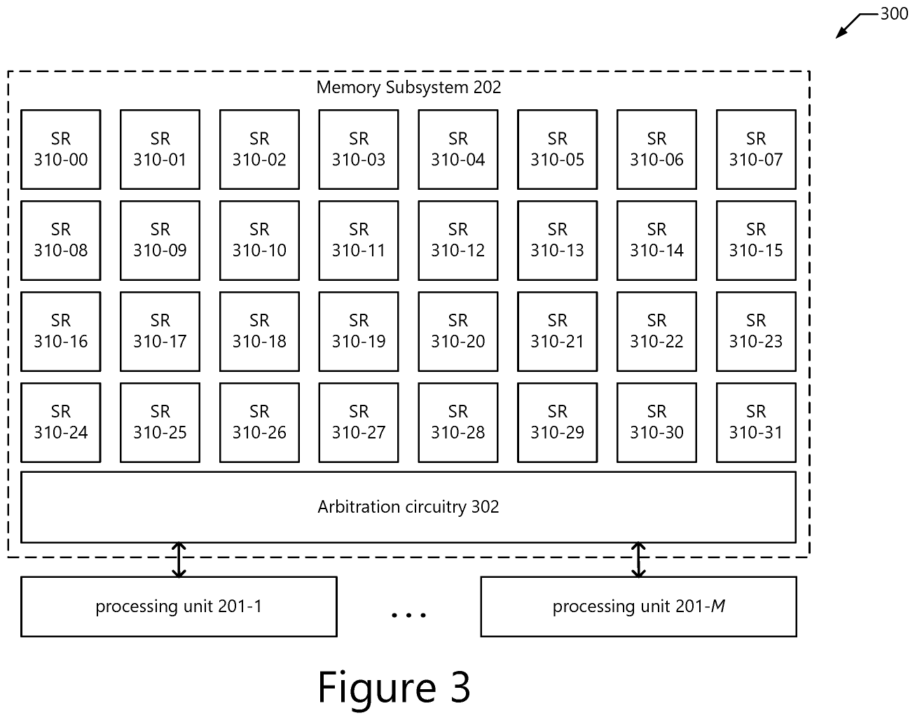

FIG. 3 illustrates an example memory subsystem architecture 300, which shows components/elements of the memory subsystem 202. In this example, the memory subsystem 202 includes a plurality of shared resources (SRs) 310 (labelled as SRs 310-00 to 310-31 in FIG. 3) and access arbitration circuitry (“arbiter”) 302. The arbiter 302 obtains write data from individual processing units 201, and handles the storage of the obtained write data in one or more SRs 310 according to the various techniques discussed infra. The data may be obtained from individual processing units 201 and stored in one or more SRs 310 based on write commands issued by the individual processing units 201. The arbiter 302 also obtains read data from one or more SRs 310, and provides the read data to individual processing units 201 according to the various techniques discussed infra. The data may be obtained from one or more SRs 310 and provided to the individual processing units 201 based on read commands issued by the individual processing units 201.

The arbiter 302 perform address translation to translate virtual memory addresses used by software elements (e.g., programs, processes, threads, and the like operated by individual processing units 201) to physical memory addresses for storage and retrieval of data from the physical memory SRs 310. For example, the arbiter 302 may include or have access to a page table that maps virtual memory pages/addresses to physical memory pages/addresses. The page table includes an entry for each virtual page, indicating its location in physical memory. Each access instruction/request may involve a page table access followed by a physical memory access, where the page table access involves the arbiter 302 translating the virtual address included in the request to a physical address, and then using the physical address to actually read or write the data. In some examples, the page table may be implemented as a second level address translation table (SLAT), an extended page table (EPT), or some other suitable page table implementation. As discussed in more detail infra, the arbiter 302 can directly manipulate the addresses of shared resources to maximize the overall access bandwidth and/or provide some form of address space transformation. Additionally, the arbiter 302 provides other support capabilities for the memory subsystem 202 that are used in conjunction with the processing units 201 and/or a host platform. These support capabilities include, for example, timing/clock capabilities, input/output (I/O) capabilities, manageability capabilities, and/or the like. In some implementations, the arbiter 302 is a memory controller and/or input/output (I/O) controller such as, for example, those discussed infra with respect to interface circuitry 2370 of FIG. 23. In these implementations, the arbiter 302 can include various hardware elements such as a control module that controls data access operations to the memory subsystem 202 and translates the commands and addresses as discussed herein; a data-path module to process data sent and received by the arbiter 302; an I/O module to write and read data and commands, and to generate clock signals for accessing and performing other operation on the memory subsystem 202; various data registers; and/or other like elements.

The SRs 310 (also referred to as “RAM cuts 310”, “memory blocks 310”, or the like) are physical and/or virtual areas of the memory subsystem 202 in which data can be stored and/or retrieved. In various implementations, each SR 310 is a continuous chunk or cut of memory and each SR 310 has a same size or capacity. In this example, the memory subsystem 202 includes thirty-two (32) SRs 310.

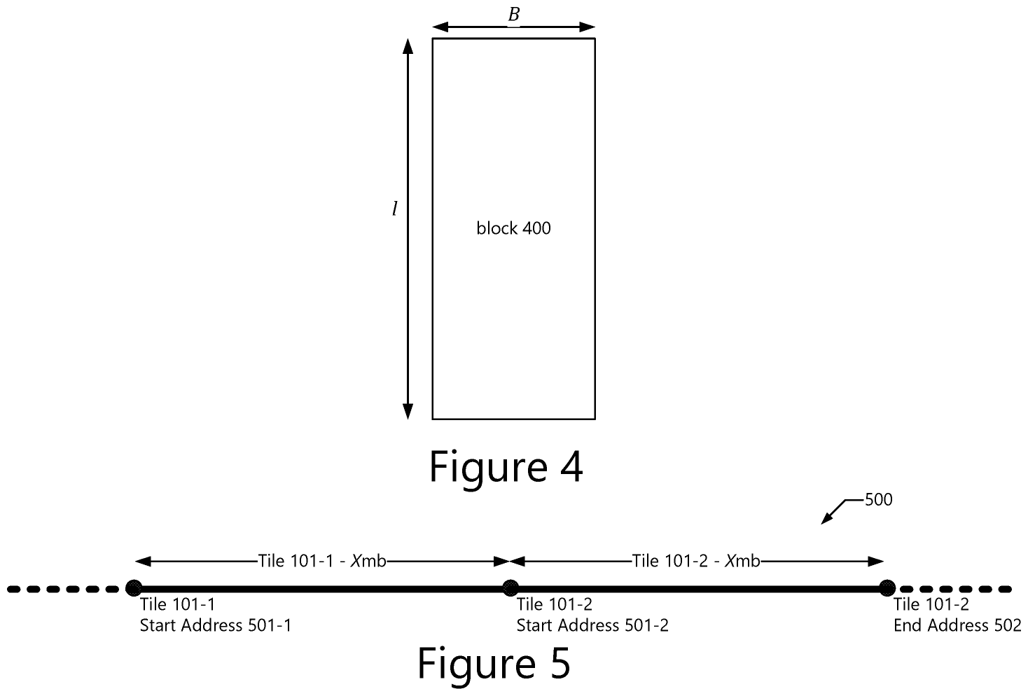

FIG. 4 shows an example memory block 400, which may correspond to any of the memory SRs 310 in FIG. 3. The memory block 400 has a bit width of B bytes and a bit length of l lines. In an example, the memory block 400 is 16 bytes (B) (or 128 bits) in width (e.g., B=16) and 4096 lines in length (e.g., l=4096), which means that the memory block 400 has a size or capacity of 64 kilobytes (KB) (e.g., 16B×4096=64 KB). In this example, the memory subsystem 202 has a size of two (2) megabytes (MBs) (e.g., 32 blocks×64 KB=2 MB).

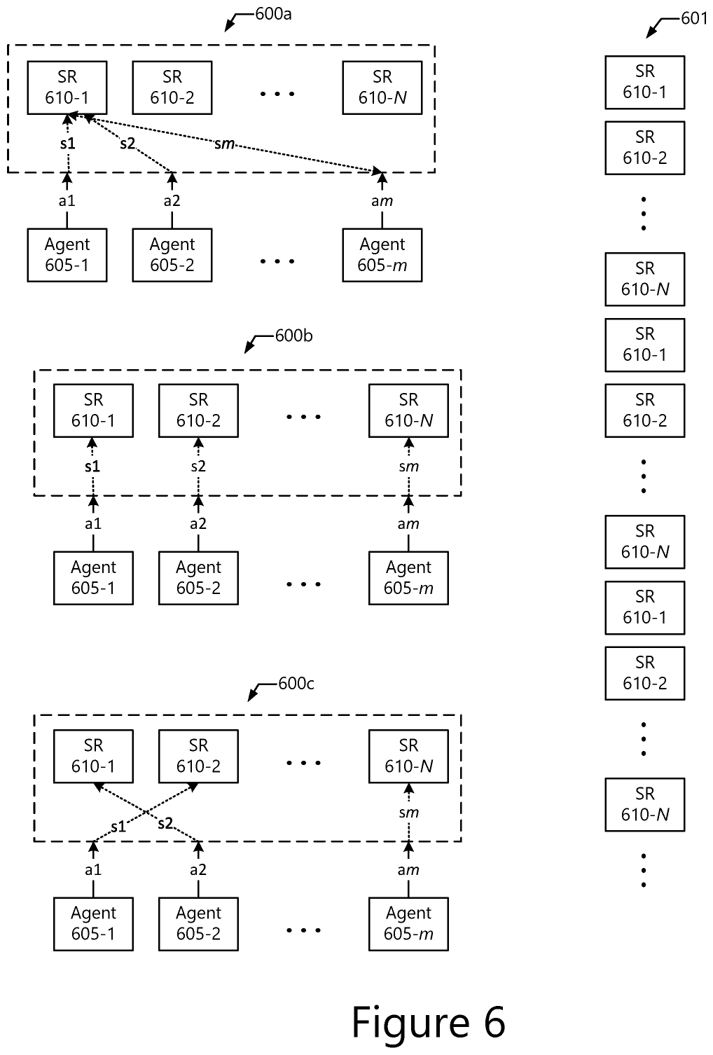

FIG. 5 shows an example address scheme 500 for the memory subsystem architecture 300. In particular, FIG. 5 shows an example memory address range for compute tiles 101, where each compute tile is X MB in size (e.g., where X=2 MB). In this example, compute tile 101-1 has a start address 501-1, and compute tile 101-2 has a start address 501-2. Additionally, compute tile 101-2 has an end address 502. Additionally or alternatively, the start address 501-2 may also be considered an end address for compute tile 101-1.

Each SR 310 is assigned a memory address, where each memory address maps to a corresponding SR 310. In the example of FIGS. 3-5, the memory address of each SR 310 is 16B apart from a next SR 310. An example memory address allocation is shown by Table 1.

TABLE 1
example shared resource (SR) to memory address mapping

| SR Number | Memory Address |
|---|---|
| SR 310-00 | 0x2E000000 |
| SR 310-01 | 0x2E000010 |
| SR 310-02 | 0x2E000020 |
| SR 310-03 | 0x2E000030 |
| SR 310-04 | 0x2E000040 |
| SR 310-05 | 0x2E000050 |
| SR 310-06 | 0x2E000060 |
| SR 310-07 | 0x2E000070 |
| SR 310-08 | 0x2E000080 |
| SR 310-09 | 0x2E000090 |
| SR 310-10 | 0x2E0000A0 |
| SR 310-11 | 0x2E0000B0 |
| SR 310-12 | 0x2E0000C0 |
| SR 310-13 | 0x2E0000D0 |
| SR 310-14 | 0x2E0000E0 |
| SR 310-15 | 0x2E0000F0 |
| SR 310-16 | 0x2E000100 |
| SR 310-17 | 0x2E000110 |
| SR 310-18 | 0x2E000120 |
| SR 310-19 | 0x2E000130 |
| SR 310-20 | 0x2E000140 |
| SR 310-21 | 0x2E000150 |
| SR 310-22 | 0x2E000160 |
| SR 310-23 | 0x2E000170 |
| SR 310-24 | 0x2E000180 |
| SR 310-25 | 0x2E000190 |
| SR 310-26 | 0x2E0001A0 |
| SR 310-27 | 0x2E0001B0 |
| SR 310-28 | 0x2E0001C0 |
| SR 310-29 | 0x2E0001D0 |
| SR 310-30 | 0x2E0001E0 |
| SR 310-31 | 0x2E0001F0 |

The memory subsystem 202 can provide a virtual memory to provide the illusion of having a larger memory space/capacity. In these implementations, the collection of SRs 310 constitute the physical memory (or main memory) of the system, and multiple virtual addresses will be mapped to one physical SR 310. The virtual address mappings can be expressed using equation 1.

a=s+l×L+n×B (1)

In equation 1, a is the access (virtual) address for line/requested by an access agent within its address space, s is the start address for a compute tile 101 (e.g., which may correspond to a memory address in Table 1), l is the number of lines (bit length) per SR 310 (e.g., 0≤l≤4095 in the examples of FIGS. 3-5), n is the memory block number (e.g., 0≤n≤31 in the examples of FIGS. 3-5) corresponding to s (see e.g., Table 1), B is the number of bytes (bit width) per SR 310 (e.g., B=16 in the examples of FIGS. 3-5), and L is the total physical address space length (e.g., L=512 bytes in the examples of FIGS. 3-5). Based on equation 1, all addresses a map to the same block n. Equation 1 governs how physical addresses are assigned to individual SRs 310 (e.g., memory blocks). An access agent requests an address in another logical (virtual) address space, and this logical (virtual) address will eventually get mapped to a physical address via the memory controller (e.g., arbiter 302). In some implementations, a data access stride D can be used instead of the number of bytes B. Here, the physical address mapping can be implemented to have a data access stride of D bytes where D B between consecutive SRs 310.

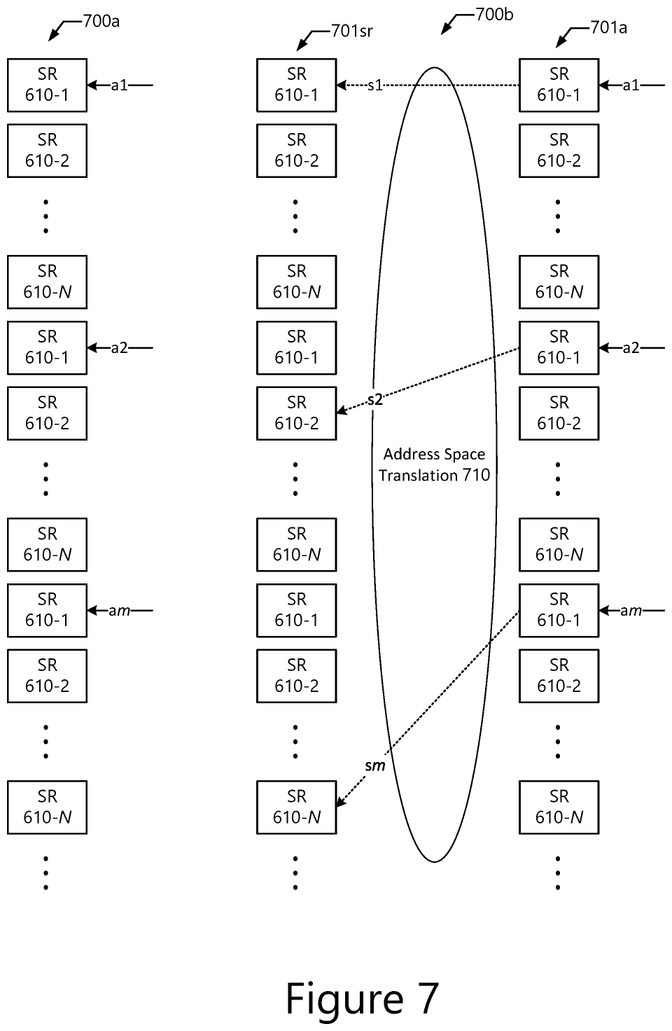

The virtual address space itself is larger than the actual physical memory size, so at some point during operation, the arbiter 302 will eventually wrap back around to store data within the same memory block (SR). In the examples of FIGS. 3-5, the arbiter 302 will wrap back around to the same location every 512B. However, this may lead to contention issues when multiple access agents attempt to access the same SR 310 during the same transaction cycle (or clock cycle), as is demonstrated by FIG. 6. These contention issues may arise based on various HW constraints, for example, the capability of only one port 212, 213 being able to access a physical SR 310 during each physical transaction cycle.

FIG. 6 depicts various access scenarios 600a, 600b, and 600c, as well as a linear address space configuration 601. In each access scenario 600a, 600b, 600c, individual access agents 605 (labeled access agent 605-1, 605-2, . . . , 605-m, where m is a number of access agents) attempt to access SRs 610 (labeled SR 610-1, 610-2, . . . , 610-N, where N is a number of SRs) during a transaction cycle. The SRs 610 may be the same or similar as the SRs 310 discussed previously. Each access agent 605 can be a process, a task, a workload, a subscriber in a publish and subscribe (pub/sub) data model, a service, an application, a virtualization container and/or OS container, a virtual machine (VM), a hardware subsystem and/or hardware component within a larger system or platform, a computing device, a computing system, and/or any other entity or element such as any of the entities or elements discussed herein. In some implementations, the access agents 605 are data readers and writers for the various instances of the processing units 201. Additionally, when requesting access to an SR 610, each access agent 605 sends a request message or signal including an access agent address (e.g., virtual address). For example, access agent 605-1 sends a request including or indicating access agent address a1, access agent 605-2 sends a request including or indicating access agent address a2, and so forth to access agent 605-m sends a request including or indicating access agent address am. Furthermore, the arbiter 302 translates the access agent addresses into an SR address (e.g., physical address) according to a linear address space mapping 601. For example, access agent address a0 can be translated into an SR address s1, access agent address a2 can be translated into an SR address s2, and so forth to access agent address am being translated into an SR address sm.

A common design problem involves a finite set of resources that can be accessed by various agents. Selecting the right temporal arbitration scheme will affect performance and/or resource consumption. Implementation limitations lead to the constraint of having a single access agent 605 interacting with an SR 610 per transaction cycle. A hazard condition occurs when all of the access agents 605 request (or attempt to access) the same SR 610 in a transaction cycle. An example is shown by access scenario 600a where all of the access agents 605 request the same shared resource SR 610-1 in a transaction cycle. In access scenario 600a, only one access agent 605 will be granted access and the remaining (m−1) will wait for another candidate cycle. The effective bandwidth in this scenario is divided by N. Access scenario 600a can also be referred to as a minimum bandwidth scenario. In an example where the SRs 610 have the same dimensions or parameters as the memory block 400, access scenario 600a has a memory bandwidth of 16B because only one input port 212 can access the SR 610-1 during a transaction cycle (e.g., clock cycle) causing the other input ports 212 to stall and wait until the next cycle to get serviced.

If each access agent 605 is mapped to a single shared resource SR 610 per transaction cycle, maximum bandwidth is achieved. Access scenarios 600b and 600c demonstrate two examples for achieving maximum bandwidth. In access scenario 600b, access agent 605-1 accesses SR 610-1, access agent 605-2 accesses SR 610-2, and so forth to access agent 605-m accessing SR 610-N. In access scenario 600b, access agent 605-1 accesses SR 610-2 and access agent 605-2 accesses SR 610-1. In each access scenario 600b, 600c the input ports 212 are requesting addresses that map to a single SR 610. In an example where the SRs 610 have the same dimensions or parameters as the memory block 400, the maximum bandwidth for access scenarios 600b and 600c is 16B×32 SRs=512B/transaction cycle.

According to various embodiments, the arbiter 302 maps the access agents 605 to the SRs 610 so maximum performance in terms of bandwidth usage is achieved. In some implementations, the data requested by the access agents 605 is mapped to a linear address space 601. In some implementations, the linear address space 601 includes a one-to-many mapping between an individual SR 610 and the access agent addresses and/or where several discrete access agent addresses are mapped to the same SR 610. This one-to-many mapping of access agent addresses to SRs 610 is possible since Nis smaller than the size of the access agent address space. The access agent address space has in the order of millions of unique addresses, while the number of SRs 610 (e.g., “N”) is less than 64 in this example.

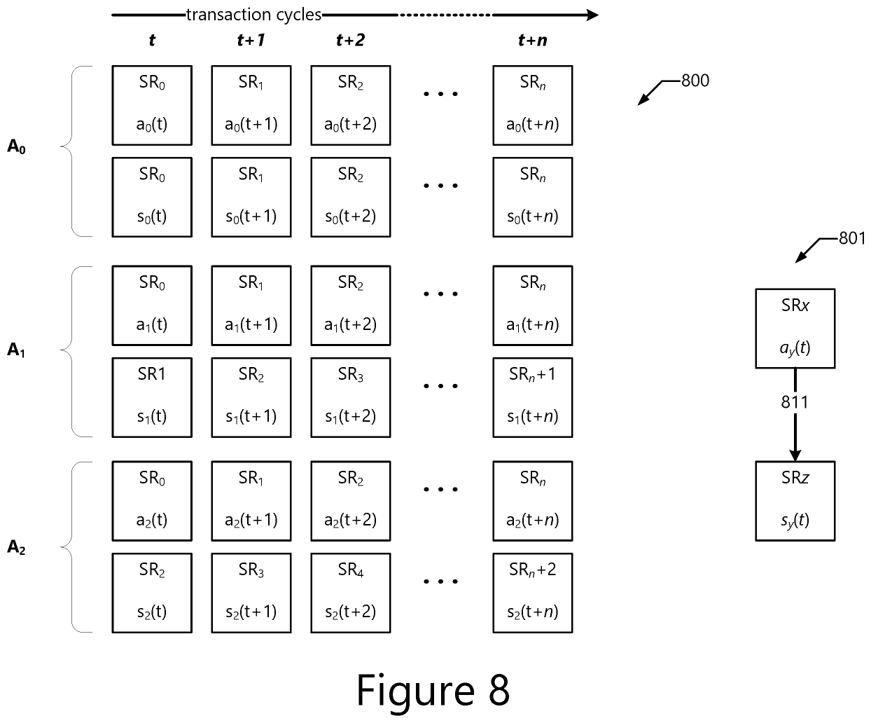

FIG. 7 shows example linear address space configurations 700a and 700b. For the access agents 605 requesting data using linear addresses, several transaction addresses can map to the same SR 610. The linear address space configuration 700a shows an example of access agents 605 requesting addresses a1, a2, . . . , am in the same transaction cycle. Here, all of the access agent addresses map to the same SR 610 (e.g., SR 610-1). This example may correspond to the access scenarios 600a in FIG. 6. There will be a performance penalty for these access collisions per transaction cycle.

In various implementations, two separate address spaces are maintained for the SRs 610 (e.g., address space 701sr in FIG. 7) and access agents 605 (e.g., address space 701a in FIG. 7). All requested access agent addresses 701a for the access agents 605 undergo a translation 710 (or transformation 710) before entering the SR address space 701sr. The address translation 710 may be referred to as “address staggering” or “swizzling”. Address staggering (or swizzling) reduces the probability of access collision as demonstrated in FIG. 7.

In linear access space configuration 700b, the access agents 605 request access agent addresses a1, a2, . . . , am, and the arbiter 302 performs address space translation 710 on the access agent addresses. The access agent addresses a1, a2, and am in the address space 701a are translated, transcoded, transformed, or otherwise converted or changed into s1, s2, and sm in the SR address space 701sr, respectively. Before the address staggering 710, addresses a1, a2, and am map to the same SR 610-1. The address space translation 710 guarantees that these addresses map to separate SRs 610 in the SR address space 701sr (e.g., a1 being mapped to 610-1, a2 being mapped to 610-2, and am being mapped to 610-N in address space 701sr). In this way, access collisions can be avoided.

In various implementations, individual access agents 605 can request an access agent address a_{y}(t) at transaction cycle t. Equation 2 shows a relationship between a_{y}(t) and a_{y}(t+1) where a_{y} is an access agent 605, a_{y}(t) is an access agent address request from access agent a_{y} at transaction cycle t, a_{y}(t+1) is a next access agent address request from the access agent a_{y} at transaction cycle t+1, and D is the data access stride (which in this example is a constant value).

a_{y}(t+1)=a_{y}(t)+D (2)

For applications where the access agents' 605 temporal access pattern is governed by equation 2, address staggering provides a mechanism for choreographing zero collisions per transaction cycle (or near zero access collisions per cycle).

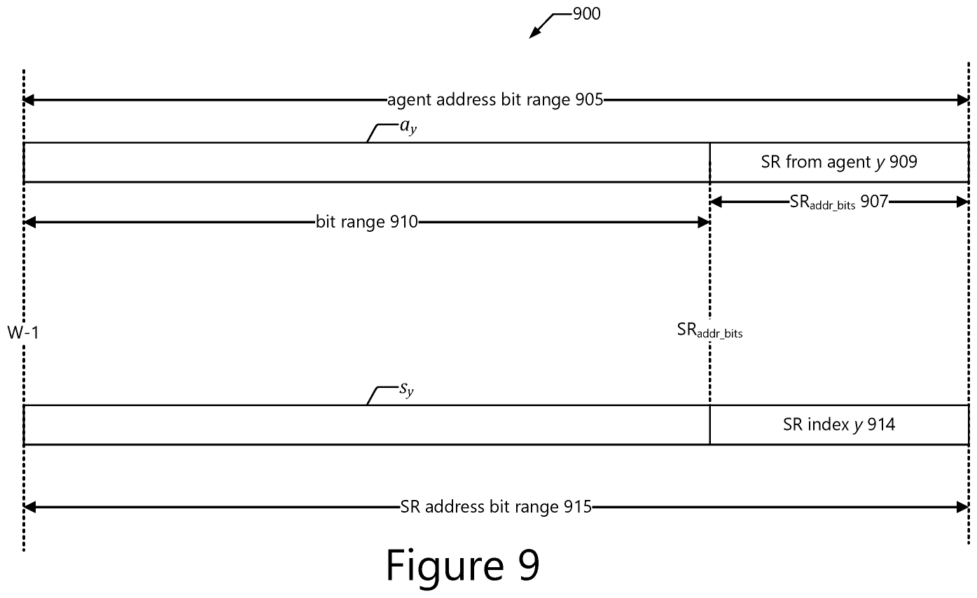

FIG. 8 shows an example temporal access pattern 800 for access agents A₀, A₁, and A₂ at transactions cycles t, t+1, t+2, . . . , t+n, where t and n are numbers. In the agent address space, the agents A₀, A₁, and A₂ request addresses a₀ (t), a₁(t), and a₂ (t), which are transformed into SR addresses s₀ (t), s₁(t), and s₂(t) in the SR address space. This guarantees little or no collisions at each transaction cycle. Here, the agent addresses a₀(t), a₁(t), and a₂(t) map to the same SR at each transaction cycle t. However, the address transformation due to staggering of SR addresses s₀ (t), s₁(t), and s₂ (t) allows each agent to access a single SR. In this example, there is a relative phase shift amongst the access agent-SR mapping. At transaction cycle t, agents a₀, a₁, and a₂ request SR₀, SR₁, and SR₂, respectively.

The temporal access pattern 800 includes a mapping 801 wherein an SR address s_{y} for access agent A_{y} is derived from the request address a_{y}. The mapping 801 includes a shared resource SRₓ that is mapped to access agent address a_{y} (t), and a shared resource SR_{z} that is mapped to address s_{y} (t) at transaction cycle t. The shared resource SR_{z} is accessed 811 by access agent y at transaction cycle t due to address staggering or swizzling.

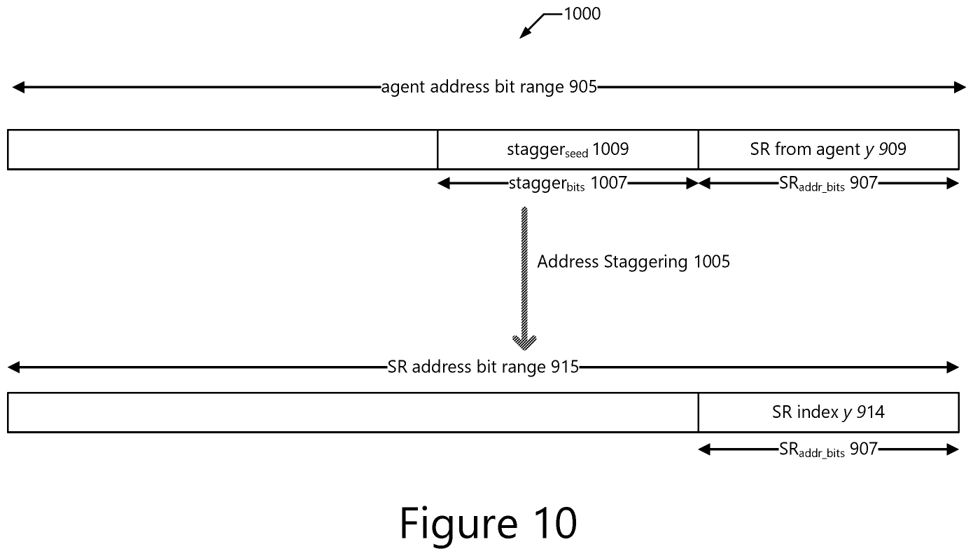

FIG. 9 shows an example mapping 900 of access agent address a_{y} to shared resource address s_{y}. As alluded to previously, an SR address s_{y} is derived from an access agent address a_{y}. The access agent address a_{y} is a suitable data unit or datagram in a format according to the protocol used to convey the access agent address a_{y} from the access agent to the arbiter 302. In this example, both addresses are W bits wide. In particular, the agent address bit range 905 is a_{y}−W bits wide and the SR address bit range 915 is s_{y}−W bits wide.

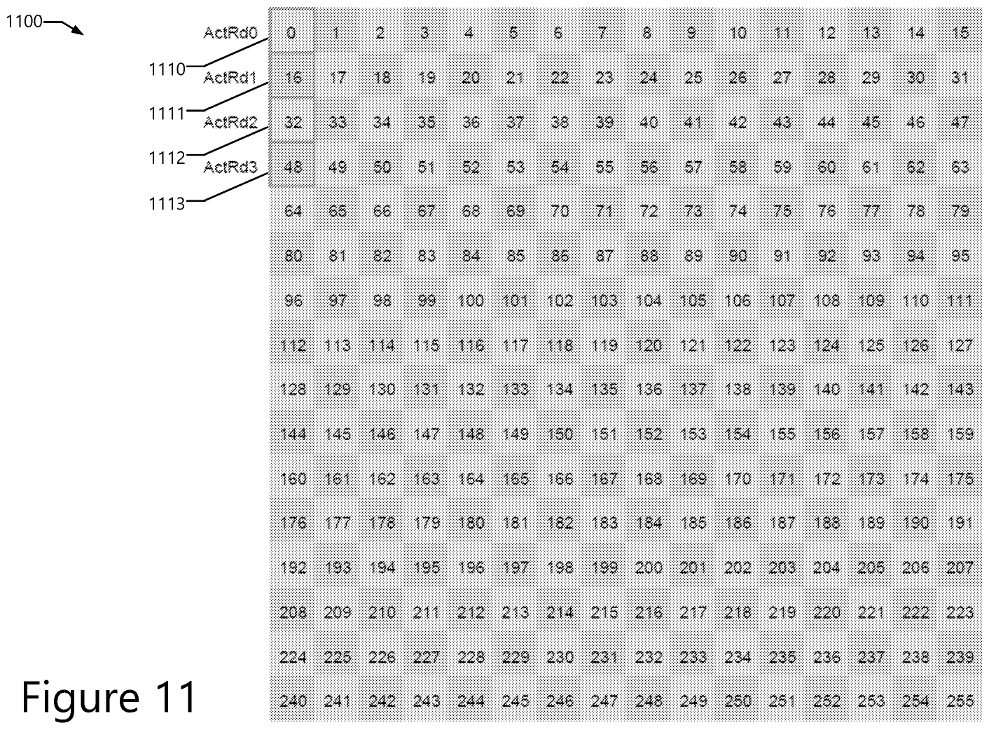

The bits in the bit range 910 is/are copied directly (verbatim) from the agent address a_{y} to the SR address s_{y}. Here, the bit range 910 is a bit range of SR_{addr}_{_{bits}} to (W−1). Additionally, the SR_{addr}_{_{bits}} bit width 907 is SR_{addr}_{_{bits}}=log₂ (N), where N is a number of SRs. The differences between addresses a_{y} and s_{y} are at the bit range 0 to SR_{addr}_{_{bits}}−1. For SR address s_{y}, this bit range is referred to as the SR index y (SRᵢ_{_{y}}), where 0≤SRᵢ_{_{y}}≤N−1. The SR index y bit field 914 contains the SRᵢ_{_{y}}. The SRᵢ_{_{y}} of the shared resource SR[SRᵢ_{_{y}}] is mapped to the requested address a_{y} of agent A_{y}. The SRᵢ_{_{y}} is calculated or otherwise determined from the SR from agent y (SRₐ_{_{y}}), which is included in the SR from agent y bit field 909 and a stagger seed value (shown and described with respect to FIG. 10). Additionally, the SRₐ_{_{y}} and/or bit field 909 in agent address a_{y} and the SRᵢ_{_{y}} and/or bit field 914 in SR address s_{y} can be different depending on the address staggering.

FIG. 10 shows an example address staggering 1000 where the requested address a_{y} from agent A_{y} is used to calculate the SR address s_{y}. The SRᵢ_{_{y}} bit field 914 of s_{y} influences which SR is to be accessed. In this example, the address staggering transformation 1005 (which may be the same or similar as the transformation 710 discussed previously) uses the SRₐ_{_{y}} and a stagger seed value (stagger_{seed}) to determine the SR address s_{y}.

The address staggering transformation 1005 obtains the SRₐ_{_{y}} from the lower SR_{addr}_{_{bits}} log₂ (N) bits of the agent address a_{y}. The lower SR_{addr}_{_{bits}} bits may be the value included in the SR from agent y bit field 909 and/or a predefined number of least significant bits of the address a_{y}. The address staggering transformation 1005 also extracts the stagger from the stagger seed bit field 1009 in the address a_{y}. The stagger seed bit field 1009 has a bit width 1007 of stagger_{bits}. Additionally, the number of stagger_{bits} (e.g., bit width 1007) used in the address staggering transformation 1005 is between 0 and SR_{addr}_{_{bits}} (e.g., 0≤stagger_{bits}≤SR_{addr}_{_{bits}}).

When stagger_{bits}=0, no address transformation 1005 takes place, and a_{y}=s_{y}. When a_{y}=s_{y}, the arbiter 302 may simply use the address a_{y} to obtain the data stored at the SR address s_{y}. The shared resource SR[SRᵢ_{_{y}}] that services an agent's request for address a_{y} is determined using the SRᵢ_{_{y}} in the bit field 914 of address s_{y}. In an example, the SRᵢ_{_{y}} is calculated according to equation 3.

SRᵢ_{_{y}}=SRₐ_{_{y}}+stagger_{seed}<<(SR_{addr}_{_{bits}}−stagger_{bits}) (3)

In equation 3, “<<” is a binary shift left operation. In one example implementation, the compute unit 100 is a neural network accelerator with a shared SRAM device where N=32, which means that SR_{addr}_{_{bits}}=5. Simulation results show that, where stagger_{bits}=SR_{addr}_{_{bits}}=5, a 40% improvement in DPU performance can be obtain in comparison to a baseline implementation without address staggering. This baseline implementation without address staggering has stagger_{bits}=0. The actual improvement realized will be implementation-specific and may be based on the particular technical constraints of the use case in question.

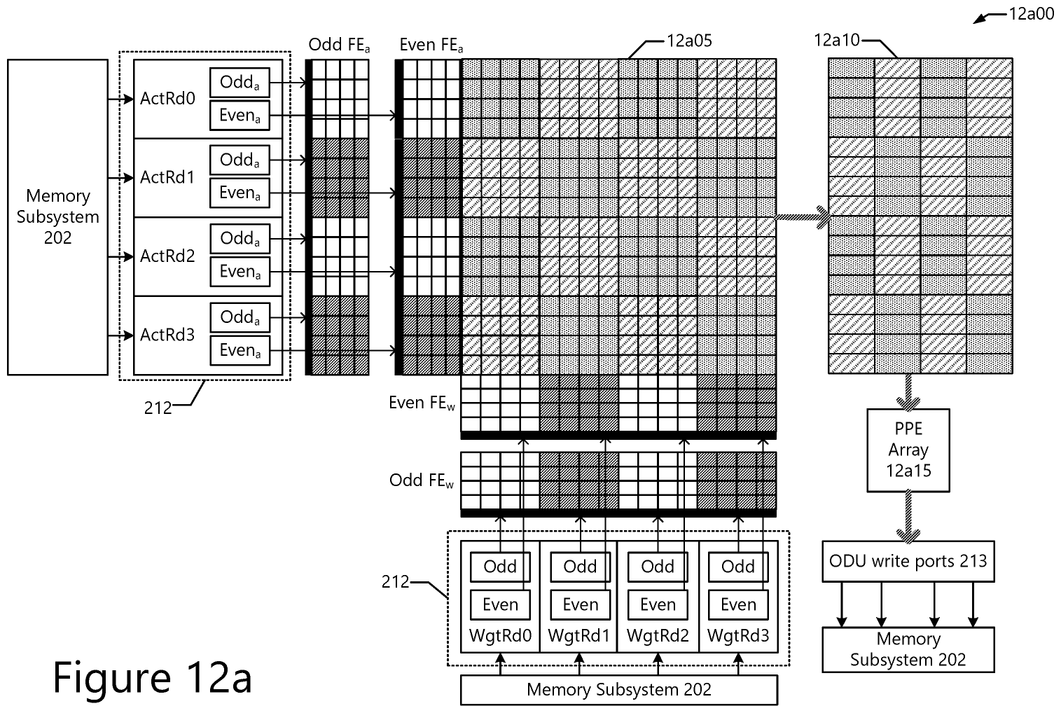

FIG. 11 depicts an example activation tensor 1100. The activation tensor 1100 is a three dimensional (3D) matrix that is 16 elements long, 16 elements wide, and 128 channels deep. In this example, the activation tensor 1100 is 50% dense, which means that half of the elements in the activation tensor 1100 contain data. In this example, a peak bandwidth of 256B per clock cycle can be achieved where only half of the RAM cuts are unused for storing the tensor 1100. Other tensor densities can be used in other examples. In some implementations, the activation tensor 1100 can be compressed for storage where only non-zero values are stored. In one example, the tensor 1100 may be compressed and stored using ZXY packing or NHWC packing (where “NHWC” refers to the following notation for the activations: batch N, channels C, depth D, height H, width W). Other data formats may be used in other implementations such as, for example, NCHW, CHWN, nChw8c, and/or the like (see e.g., ONEDNN DEVELOPER GUIDE AND REFERENCE, Intel® oneAPI Deep Neural Network Library Developer Guide and Reference version 2022.1 (11 Apr. 2022), the contents of which are hereby incorporated by reference in its entirety). In another example, zero value compression (ZVC) is used for compressing the tensor 1100. ZVC involves compressing randomly spaced zero values in a data structure and packing the non-zero values together (see e.g., Rhu et al., Compressing DMA Engine: Leveraging Activation Sparsity for Training Deep Neural Networks, arXiv:1705.01626v1 [cs.LG], pages 1-14 (3 May 2017)). In these implementations, metadata is also stored indicating where the zero values are located within the tensor 1100. In one example, the metadata can be in the form of a bitmap or the like. The numbers in each tensor element in the activation tensor 1100 represent a cell or tensor element number/identifier, and do not necessarily reflect the actual value store in the corresponding cell/element. In one example, the tensor elements in the activation tensor 1100 include pixel data values of an input image or frame for a convolutional neural network (CNN).

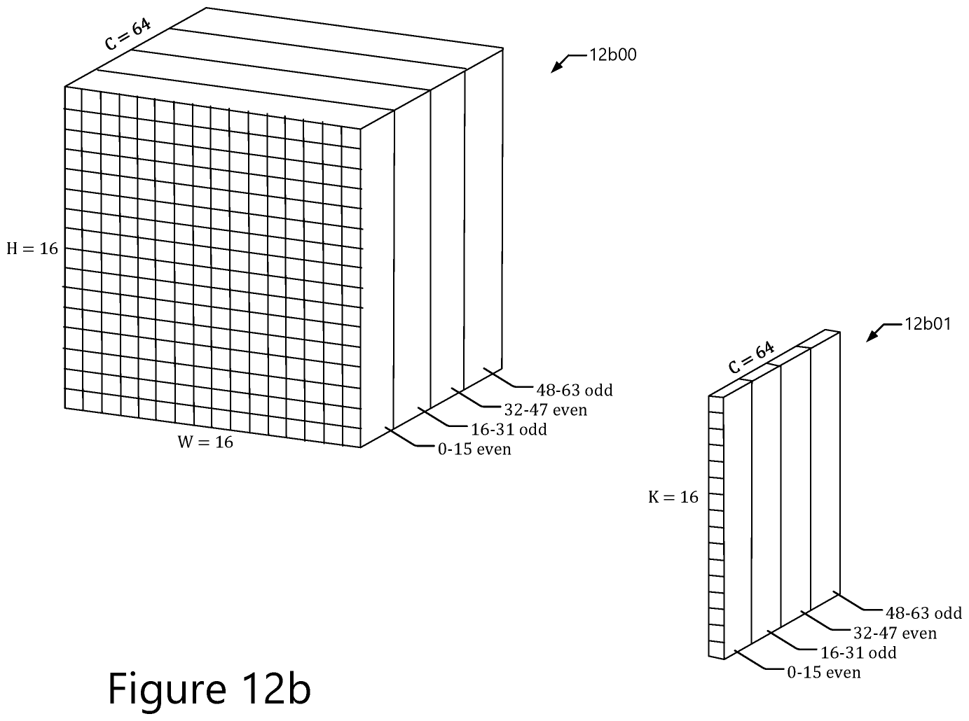

FIG. 12a shows a logical arrangement 12a00 of a processing unit 201, and FIG. 12b shows an example input tensor 12b00. The example of FIGS. 12a and 12b is discussed infra in context of the processing unit 201 being a DPU processing or operating a CNN for image classification in the computer vision domain. However, other tasks such as object detection, image segmentation, and captioning could also benefit from the sparse distillation embodiments discussed herein. Furthermore, the processing unit 201 implementations discussed herein can be straightforwardly applied to other AI/ML domains, architectures, and/or topologies such as, for example, recommendation systems, acoustic modeling, natural language processing (NLP), graph NNs, recurrent NNs (RNNs), Long Short Term Memory (LSTM) networks, transformer models/architectures, and/or any other AI/ML domain or task such as those discussed elsewhere in the present disclosure.

In this example, the processing unit 201 includes four activation readers (ActRds) including ActRd0, ActRd1, ActRd2, and ActRd3 in FIGS. 11 and 12a, and also includes four weights (filter) readers (WgtRds) including WgtRd0, WgtRd1, WgtRd2, and WgtRd3 in FIG. 12a. Individual elements in the tensor 1100 are read into the processing unit 201 by the ActRds as activation data. The ActRds read four independent rows of the input tensor 1100 into the processing unit 201. The boxes 1110, 1111, 1112, and 1113 in FIG. 11 indicate where ActRd0, ActRd1, ActRd2, and ActRd3, respectively, will start reading for a 1x1s1 convolution operation. Instances of the ActRds are realized through hardware, and each ActRd has its own assigned IDU port 212. The WgtRds read weights or filters into the processing unit 201 for corresponding tensor elements of the tensor 1100. Instances of the WgtRds are also realized through hardware, and each WgtRd has its own assigned IDU port 212.

Each Activation Reader (ActRd) reads 32 channels of an input tensor, such as activation tensor 12b00 of FIG. 12b, to fill activation front-end (FE) buffers (e.g., the even FEₐ and odd FEₐ in FIG. 12a) with data. The activation tensor 12b00 of FIG. 12b corresponds to the activation tensor 1100 of FIG. 11. The activation tensor 12b00 is characterized by a height H, width W, and channel C. In this example, the dimensions of tensor 12b00 include a height H of 16, width W of 16, and a depth of 64 channels C (e.g., activation tensor 12b00 is a 16×16×64 tensor). While the height and width axes/dimensions concern spatial relationships, the channel axis/dimension can be regarded as assigning a multidimensional representation to each tensor element (e.g., individual pixels or pixel locations of an input image).

Each FE buffer stores data fetched by the ActRds, which gets consumed by the compute engine and/or spatial array 12a05 (e.g., sparse cell MAC array 12a05). These 32 channels are broken down or otherwise divided into two groups of 16 channels. Data from a first group of 16 channels goes to an even FE buffer (e.g., the even FEₐ in FIG. 12a), and data from a second group of 16 channels goes to the odd FE buffer (e.g., the odd FEₐ in FIG. 12a). For example, if the channel divided by 16 is an even number, then the data may be sent to the even FEₐ, and if the channel divided by 16 is an odd number, then the data may be sent to the odd FEₐ. Each of the ActRds include an odd number filter (“oddₐ”) and an even number filter (“evenₐ”). The oddₐ sends data of the first group of 16 channels to the odd FEₐ and the evenₐ sends the second group of 16 channels goes to the even FEₐ.

Additionally, each weight reader (WgtRd) reads respective portions of a weight tensor, such as weight tensor 12b01 of FIG. 12b, to fill weight FE buffers (e.g., the even FE_{w} and odd FE_{w} in FIG. 12a) with the weights. The weight tensor 12b01 of FIG. 12b may represent a kernel filter or filter kernels (also referred to as “filter weights” or “weights”). The weight tensor 12b01 has a height of 16 (K=16), a width W of 1, and a depth of 64 channels C (e.g., weight tensor 12b01 is a 1×1×64 tensor, where K=16). Each weight FE buffer stores weight data fetched by the WgtRds. The weights are broken down or otherwise separated into two groups where weights in the first group go to an even FE buffer (e.g., the even FE_{w} in FIG. 12a) and weights in the second group go to the odd FE buffer (e.g., the odd FE_{w} in FIG. 12a). For example, even weights may be sent to the even FE_{w} and odd weights may be sent to the odd FE_{w}. Each of the WgtRds include an odd number filter (“odd_{w}”) and an even number filter (“even_{w}”), where the odd sends the odd weights to the odd FE_{w} and the even_{w} sends the even weights to the even FE_{w}.

The ActRds and/or the WgtRds present data in the FE buffers based on one or more predefined or configured tensor operations. As examples, the predefined or configured tensor operations can include element-wise addition, summing or accumulation, dot product calculation, and/or convolution operations such as three-dimensional (3D) convolutions, depthwise convolutions, and/or the like. In the example of FIG. 12a, the tensor operation involves convolving each of the filters/kernels K in the weight tensor 12b01 with the input activation data of the activation tensor 12b00 and summing (accumulating) the resulting data over the channel dimension to produce a set of output data (also referred to as “output activation data” or “output activations”), which in this example is the sparse cell array 12a05.

A computation engine of the processing unit 201 generates or otherwise includes a sparse cell array 12a05. In this example, the sparse cell array 12a05 is a data structure (e.g., array, matrix, tensor, or the like) that is 16 bits long, 16 bits wide, and 8 channels deep (e.g., a 16×16×8 array or tensor). Additionally or alternatively, the computation engine and/or the sparse cell array 12a05 is or includes a set of processing elements to operate on the input data. For example, the processing elements can include a set of MACs, a set of PPEs, and/or the like. In one example implementation, the sparse cell array 12a05 is or includes 2000 (2k) MACs.

The computation engine and/or the sparse cell array 12a05 pulls data from the FE buffers to produce output data in one or more register file (RF) buffers 12a10. The RF buffer(s) 12a10 store output(s) from the MAC sparse cell computation array 12a05. The data stored in the RF buffer(s) 12a10 is eventually drained through the post-processing element (PPE) array 12a15 and then written to memory 202 by the ODU ports 213. In this example, the RF buffer(s) 12a10 are or include two data structures (e.g., array, matrix, tensor, or the like) that are 4 bits long, 16 bits wide, and 64 channels deep (e.g., a 4×16×64×16B array or tensor), and the PPE array 12a15 is or include a 4×16 data structure (e.g., 4 bits long and 2 bits wide).

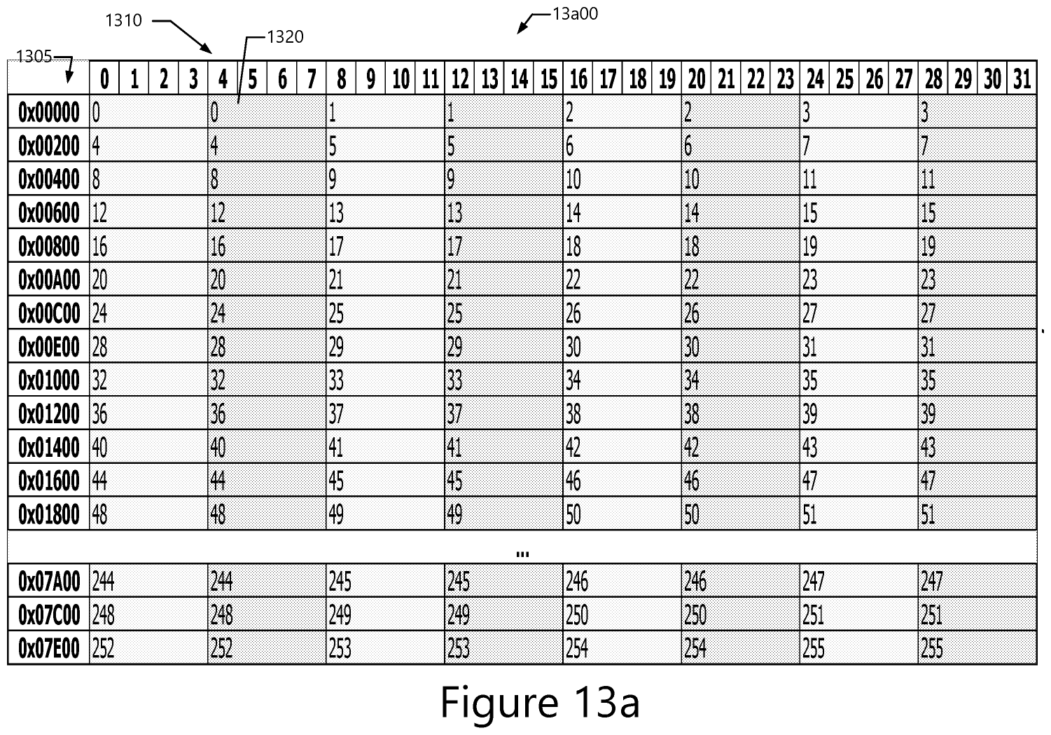

FIGS. 13a and 13b show respective arrangements or layouts of the activation tensor 1100 in the memory subsystem 202. In particular, FIG. 13a shows an activation tensor layout 13a00 representing how the tensor 1100 is stored in the memory subsystem 202 from the perspective of an access agent (e.g., individual processing units 201). The layout 13a00 and/or the address space 1305 may be a logical address space or a virtual address space for the memory subsystem 202. The layout 13a00 includes an address space 1305 in hexadecimal (e.g., from address 0x00000 to 0x07E00), where each address corresponds to a set of storage elements 1320 (note that not all storage elements 1320 are labeled in FIG. 13 for the sake of clarity). Each storage element 1320 comprises a set of SRs 1310, which may be the same or similar as the SRs 310 of FIG. 3 and/or the SRs 610 of FIG. 6. The address of an individual storage element 1320 may be based on an address of a starting SR 1310 in that storage element 1320.

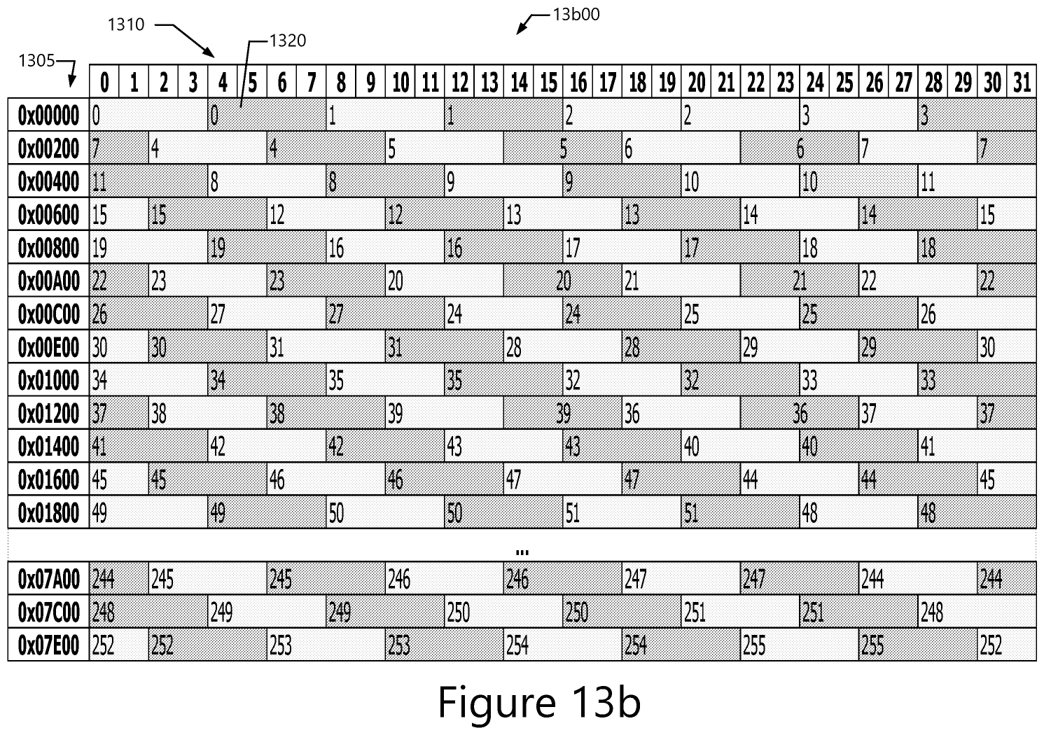

Multiple addresses 1305 may be assigned to multiple SRs 1310 and/or multiple storage elements 1320. Each storage element 1320 comprises one or more SRs 1310, and the size of each storage element 1320 (or the number of SRs 1310 making up the storage element 1320) may be referred to as a data access stride (DAS). For example, a first DAS starts at SR 0 and includes SRs 0 to 3; a second DAS starts at SR 4 and includes SRs 4 to 7, and so forth. In this example, each storage element 1320 corresponds to four SRs 1310, however, as discussed in more detail infra, the number of SRs 1310 that make up a storage element 1310 may be different depending on the staggering parameter (e.g., key 1420 of FIG. 14 discussed infra).

FIG. 13c shows an example data storage element 13c00. The data storage element 13c00 includes 128B, where a first 64B portion stores packed data and a second 64B portion includes unused data. The unused data may be used to store “allocated storage” or redundancy data in place of zero values from the tensor 1100.

As mentioned previously, the tensor 1100 is 128 bits (or 16 bytes) deep and 50% dense, which means that half of the values in the tensor 1100 are zero and another half of the values in the tensor 1100 are non-zero. In a worst case scenario, the entire 128 bits would have to be stored in the memory subsystem 202, which would require eight (8) SRs 1310 to store each tensor element because each SR 1310 is 16 bytes. Because the tensor 1100 is stored in a compressed format, only four (4) SRs 1310 per tensor element are needed to store the entire tensor 1100 in the shared memory 202. Based on the compressed storage, the zero values in the tensor 1100 are not stored in the memory subsystem 202, and instead, “allocated storage” or redundancy data is stored in place of the zero values.

In FIGS. 13a and 13b, and 13c, the non-shaded blocks represent non-zero values from a corresponding tensor element and the shaded blocks are considered allocated storage (or redundancy data). For example, referring back to FIG. 13a, a first storage element 1320 at address “0x00000” stores a value from tensor element “0” at SRs 0-3, a second storage element 1320 stores redundancy data of the tensor element “0” at SRs 4-7, a third storage element 1320 stores a value from the tensor element “1” at bit positions 8-11, a fourth storage element 1320 stores redundancy data of the tensor element “1” at SRs 12-15, a fifth storage element 1320 stores a value from tensor element “2” at SRs 16-19, a sixth storage element 1320 stores redundancy data of tensor element “2” at SRs 20-23, and so forth. Additionally, for address “0x00200”, SRs 0-3 store data of tensor element 4, SRs 4-7 store redundancy data of tensor element 4, SRs 8-11 store data of tensor element 5, SRs 12-15 store redundancy data of tensor element 5, and so forth.

If the tensor data were to be stored in the memory subsystem 202 according to layout 13a00, then only half of the SRs 1310 would be effectively used and not accessibly by the processing unit 201, and therefore, layout 13a00 can only achieve a peak bandwidth of 256B per clock cycle. FIG. 13b shows an activation tensor layout 13b00 representing how the tensor 1100 is stored in the memory subsystem 202 from the perspective of the memory subsystem 202. The layout 13b00 represents a physical address space for individual SRs 1310 in the memory subsystem 202. The layout 13b00 is one example of staggering the physical data layout 13b00 in the memory subsystem 202, which can potentially achieve maximum bandwidth.

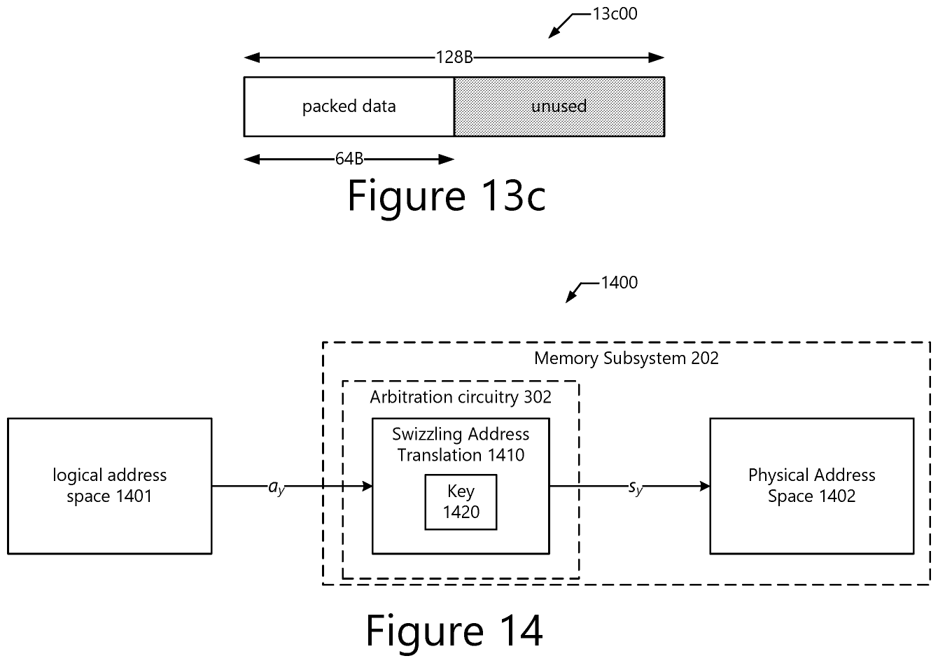

FIGS. 14 and 15 show an example of swizzling address transformation. In particular, FIG. 14 shows an example of swizzling address transformation architecture 1400, and FIG. 15 shows an example of how the access addresses are transformed or translated into SR addresses. Referring to FIG. 14, an access agent (e.g., processing unit 201) maintains a linear view of the memory subsystem 202 address space. All transactions from an access agent (e.g., processing unit 201) to the memory subsystem 202 undergo an address translation 1410. Here, the access agent (e.g., processing unit 201) sends an access address a_{y} to a swizzling address translator 1410, which is part of the arbiter 302. The access address a_{y} is part of a logical address space 1401. The swizzling address translator 1410 may be the same or similar as the translation 710 of FIG. 7, and the logical address space 1401 may be the same or similar as the address space 1305 and/or the tensor layout 13a00. The translator 1410 uses a key 1420 (also referred to as “staggering parameter 1420” or the like) to translate or convert the access address a_{y} into an SR address s_{y}, which is then used to access the data stored in the memory subsystem 202 at that SR address s_{y}. The staggered layout (e.g., layout 13b00) of storage elements (e.g., storage elements 1320) maximizes the overall effective memory access bandwidth.

FIG. 15 shows an example swizzling address translation operation for an access address 1500 (including access addresses 1500-0 through 1500-5). The access address 1500 is 22 bits in length (e.g., including bits 0 to 21) where each bit position in the access address 1500 is labeled with a corresponding number. The access address 1500 includes a routing field 1510 including a routing address (also referred to as “routing address 1510”) and a stagger seed field 1520 (also referred to as “stagger seed 1520”, “stagger bits 1520”, or “key bits 1520”). The routing address/field 1510 may be the same or similar as the SRₐ_{_{y}} and/or bit field 909, and the stagger seed/field 1520 may be the same or similar as the stagger and/or stagger seed bit field 1009.

The arbiter 302 uses the routing address 1510 and stagger seed 1520 to determine a physical routing address 1511. The physical routing address 1511 may be the same or similar as the SRᵢ_{_{y}}, the SR_{addr}_{_{bits}}, and is included in a physical routing address field of the SR address 1501 (also referred to as “address field 1511”, which may be the same or similar as the SR index y bit field 914). The number of bits in the routing address 1510 is based on the number of SRs 1310 in the shared memory subsystem 202, which can be calculated according to equation 4.

r=log₂(N) (4)

In equation 4, r is the number of bits in the routing address 1510, and N is the number of SRs 1310 in the memory subsystem 202. In this example, because there are 32 SRs 1310, the routing section 1510 includes five (5) bits to be able to identify an individual SR 1310 that a particular access address 1500 should be routed to.

The number of stagger bits 1520 is based on a key parameter 1420, which indicates a number of more significant bits (with respect to bits 4 to 8 in this example) that are used to convert the virtual routing address 1510 into a physical routing address 1511, which is inserted into the access address 1501. For example, access address 1500-0 has a key 1420 value of “0”, which means that no stagger bits are used to convert the routing address 1510; access address 1500-1 has a key 1420 value of “1” and one extra bit 1520-1 is used to convert the address bits 1510 (e.g., bit position 9); access address 1500-2 has a key 1420 value of “2” and two stagger bits 1520-2 are used to convert the address bits 1510 (e.g., bit positions 9 to 10); access address 1500-3 has a key 1420 value of “3” and three stagger bits 1520-3 are used to convert the address bits 1510 (e.g., bit positions 9 to 11); access address 1500-4 has a key 1420 value of “4” and four stagger bits 1520-4 are used to convert the address bits 1510 (e.g., bit positions 9 to 12); and access address 1500-5 has a key 1420 value of “5” and five stagger bits 1520-5 are used to convert the address bits 1510 (e.g., bit positions 9 to 13). Although the example of FIG. 15 shows the routing address 1510 including bits 4 to 8 in the access address 1500, other bits in the access address 1500 can be used in other implementations. Furthermore, although the example of FIG. 15 shows the stagger bits 1520 as being a set of bits next to the routing address 1510, in other implementations, other bits in the access address 1500 can be used as the stagger bits 1520.

The arbiter 302 performs a bitwise operation 1504, which involves adding values at bit positions 4 to 8 to the stagger bits 1520 (which in this example corresponds to the stagger bits 1520-4). The arbiter 302 inserts a result of the bitwise operation 1504 back into the address bits 4-8 thereby producing an access address 1501, which is used to access the corresponding SR 1310. As an example, where the key 1420 value is “4”, and the access address is “0x07C00” (which is the binary value of “0000000111110000000000”), the address bits 1510 are “00000” and the four stagger bits 1520-4 are “1100”. In this example, the bitwise operation 1504 yields a value of “01100”, which is inserted back into bit positions 4 to 8 to produce access address 1501 with a value of “0000000111110001100000”. In various implementations, the bitwise operation 1504 can be implemented in hardware using suitable logic circuits and the like.

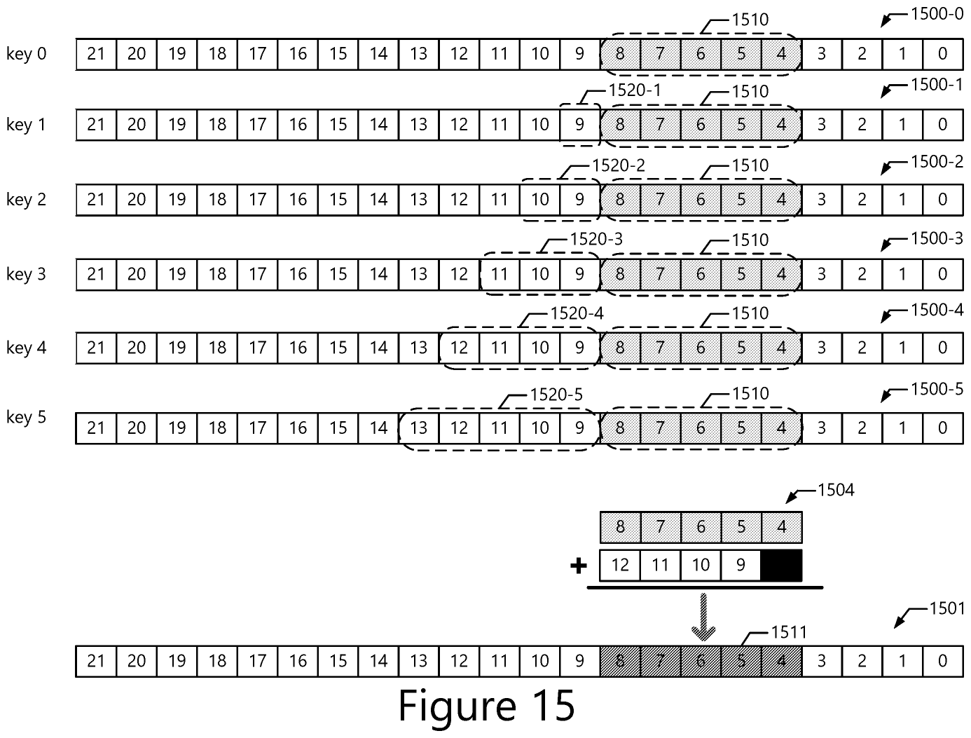

FIGS. 16-20 show example physical address spaces 1600-2000, respectively, for the activation tensor 1100 based on swizzle transformation for key parameter 1420 values of 1 to 5. When the key 1420 has a value of 0, the weight and activation data is not staggered. In each of the examples of FIGS. 16-20, the perspective of the processing unit 201 may be the same as the layout 13a00 of FIG. 13a.

FIG. 16 shows an example physical address space 1600 having a staggered storage according to key 1. This example may correspond to key 1 in FIG. 15. Here, data is staggered in blocks of N=16 SRs 1310 and/or 256B. When the key 1420 has a value of 1, the weight and activation data is aligned to 1 KB boundaries in the memory subsystem 202, and each storage element 1320 comprises sixteen SRs 1310 (see e.g., Table 2). In this example, the ActRds start fetching data from SR 0.

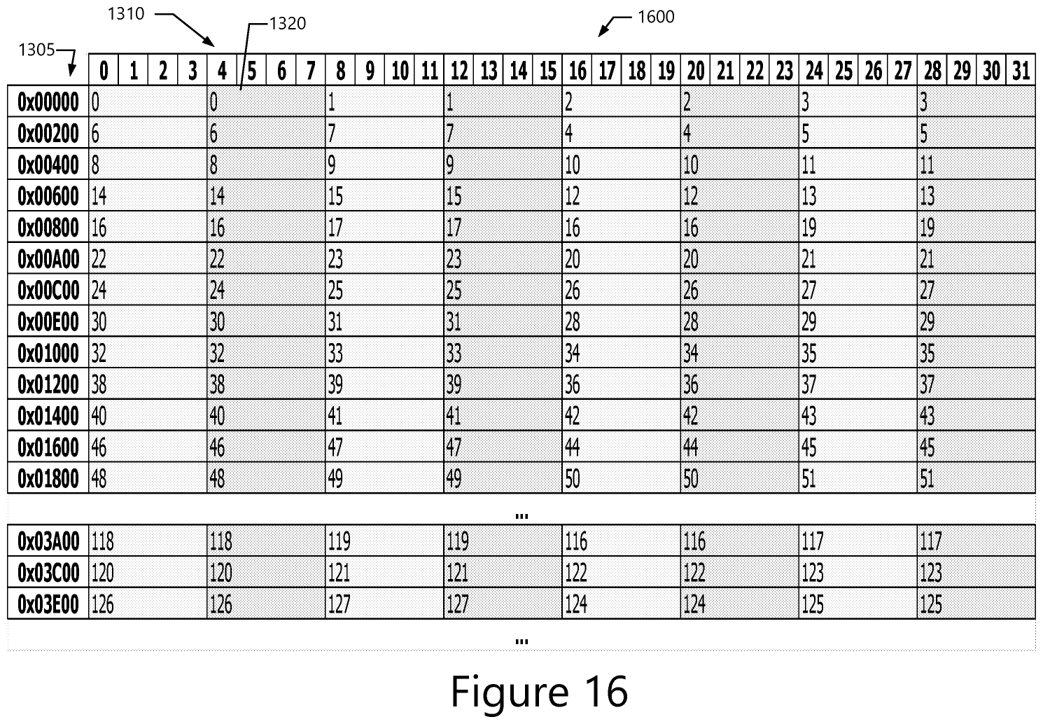

FIG. 17 shows an example physical address space 1700 having a staggered storage according to key 2. This example may correspond to key 2 in FIG. 15. Here, data is staggered in blocks of N=8 SRs 1310 and/or 128B. When the key 1420 has a value of 2, the weight and activation data is aligned to 2 KB boundaries in the memory subsystem 202, and each storage element 1320 comprises eight SRs 1310 (see e.g., Table 2). In this example, the ActRds start fetching data from SR 0.

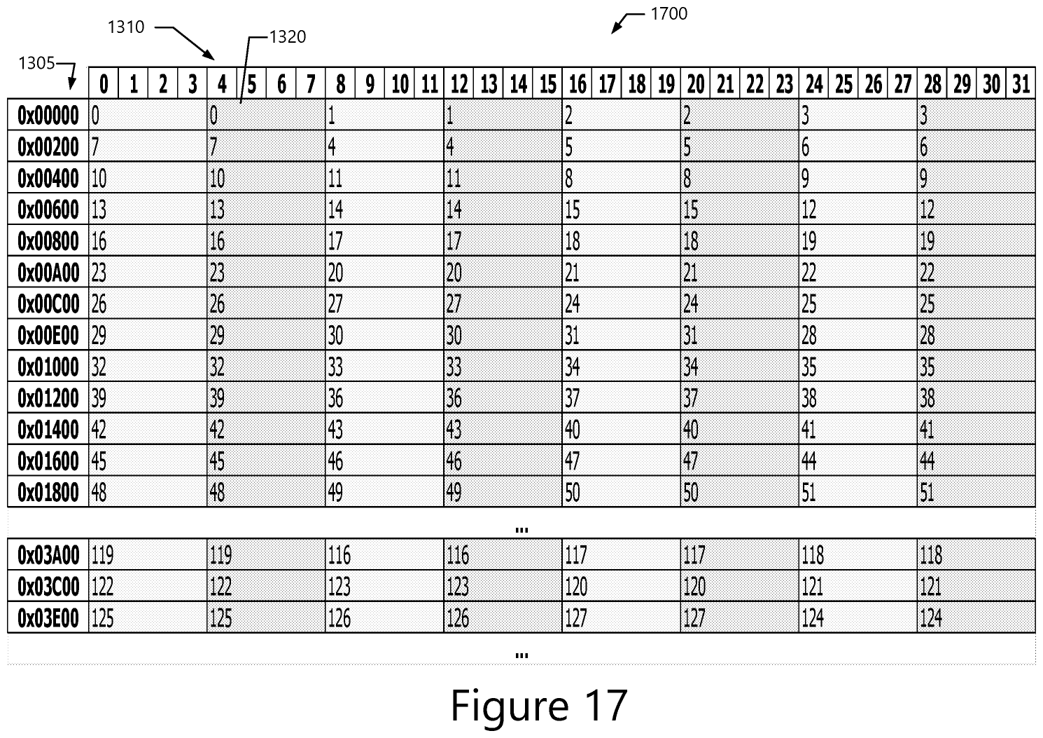

FIG. 18 shows an example physical address space 1800 having a staggered storage according to key 3. This example may correspond to key 3 in FIG. 15. Here, data is staggered in blocks of N=4 SRs 1310 and/or 64B. When the key 1420 has a value of 3, the weight and activation data is aligned to 4 KB boundaries in the memory subsystem 202, and each storage element 1320 comprises four SRs 1310 (see e.g., Table 2). In this example, the ActRds start fetching data from different SRs 1310, which in this example includes storage elements 1320 starting at SRs 0 and 16.

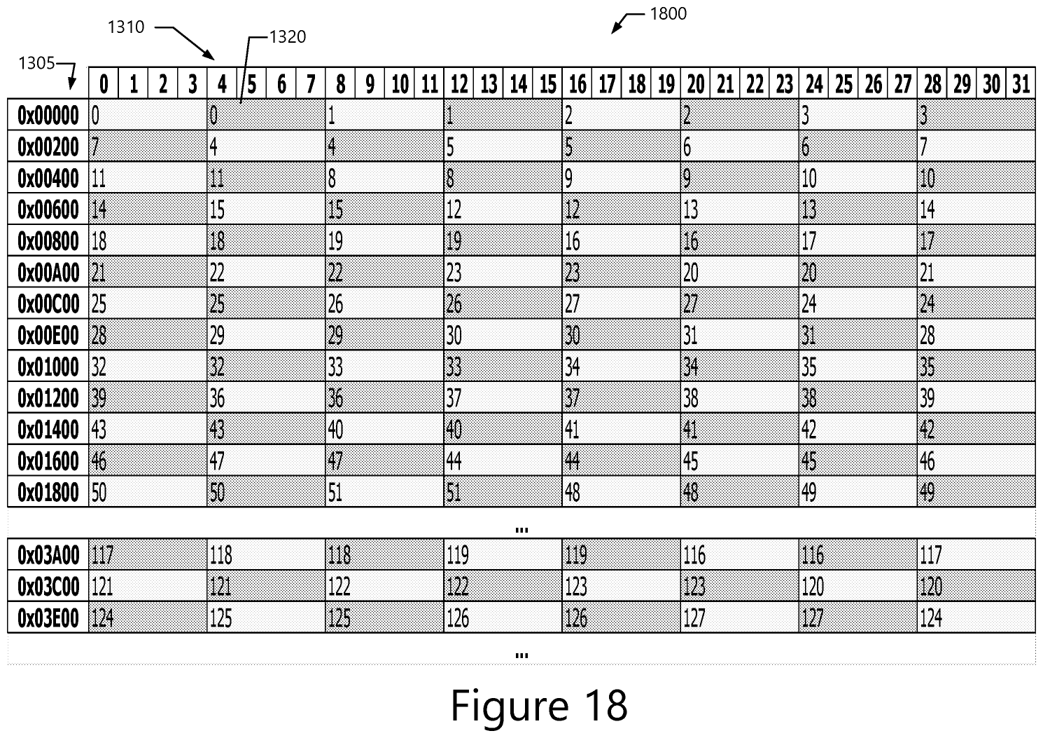

FIG. 19 shows an example physical address space 1900 having a staggered storage according to key 4. This example may correspond to key 4 in FIG. 15. Here, data is staggered in blocks of 32/2⁴=2 SRs 1310 and/or 32B. When the key 1420 has a value of 4, the weight and activation data is aligned to 8 KB boundaries in the memory subsystem 202, and each storage element 1320 comprises two SRs 1310 (see e.g., Table 2). In this example, the ActRds start fetching data from different SRs 1310, which in this example includes storage elements 1320 starting at SRs 0, 8, 16, and 24.

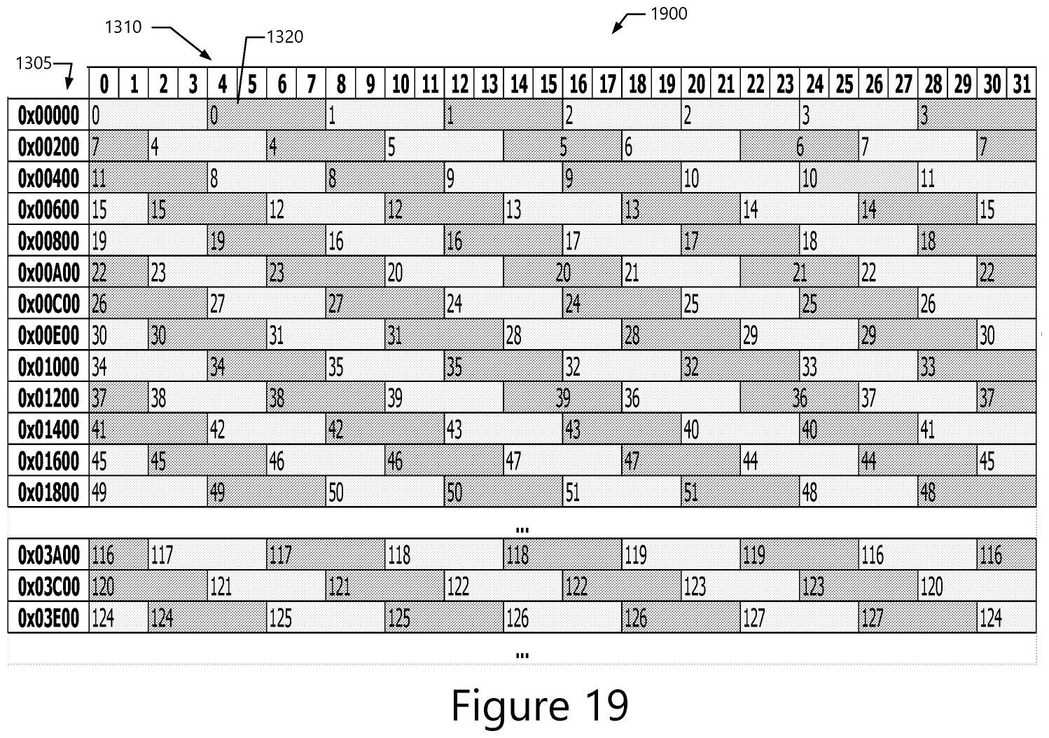

FIG. 20 shows an example physical address space 2000 having a staggered storage according to key 5. This example may correspond to key 5 in FIG. 15. Here, data is staggered in blocks of 32/2⁵=1 SR 1310 and/or 16B. When the key 1420 has a value of 5, the weight and activation data is aligned to 16 KB boundaries in the memory subsystem 202, and each storage element 1320 comprises one SR 1310 (see e.g., Table 2). In this example, the ActRds start fetching data from different SRs 1310, which in this example includes storage elements 1320 starting at SRs 0, 4, 8, and 12.

The optimal value of the key parameter 1420 may be implementation and/or use-case specific, which may have different memory alignment requirements. For example, the optimal value of the key parameter 1420 can be based on the expected activation sparsity, the tensor width, the particular AI/ML tasks or domain, and/or other parameters, constraints, and/or requirements. An optimal key 1420 value ensures that the ActRds and WgtRds start fetching from SRs 1310 in the memory subsystem 202. In the examples discussed previously, a key 1420 value of 5 provides an optimal memory access bandwidth for most workloads. In one example implementation, the processing units 201 support the use of different input activation and weight keys. In some implementations, the output activation data can be different from the input activation data (see e.g., FIG. 12a). In some implementations, a default key 1420 value can be used, which can then be reconfigured based on implementation and/or use case. Table 2 shows example swizzle key address alignment requirements based on different values of the key parameter 1420. The “Blocks” column in Table 2 determines the period in bytes for which the stagger pattern repeats itself, and the “Alignment” column indicates the alignment requirement for data to be placed at certain byte boundaries depending on the corresponding stagger key in the “Key Value” column.

TABLE 2
stagger key address alignment requirements

| Key Value | Blocks (bytes) | Alignment (KB) |
|---|---|---|
| 1 | 2¹ × 512 = 1024 | 1 KB |
| 2 | 2² × 512 = 2048 | 2 KB |
| 3 | 2³ × 512 = 4096 | 4 KB |
| 4 | 2⁴ × 512 = 8192 | 8 KB |
| 5 | 2⁵ × 512 = 16384 | 16 KB |

### 2. Example Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, and/or the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller, I/O controller, memory controller, bus controller, network connections or sessions, and/or the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, and/or the like). The orchestration functions may be used to deploy the isolated user-space instances, identifying and scheduling use of specific hardware, security related functions (e.g., key management, trust anchor management, and/or the like), and other tasks related to the provisioning and lifecycle of isolated user spaces.

Applications that have been adapted for edge computing include but are not limited to virtualization of traditional network functions including include, for example, SDN, NFV, distributed RAN units and/or RAN clouds, and the like. Additional example use cases for edge computing include computational offloading, CDN services (e.g., video on demand, content streaming, security surveillance, alarm system monitoring, building access, data/content caching, and/or the like), gaming services (e.g., AR/VR, and/or the like), accelerated browsing, IoT and industry applications (e.g., factory automation), media analytics, live streaming/transcoding, and V2X applications (e.g., driving assistance and/or autonomous driving applications).

The present disclosure provides specific examples relevant to various edge computing configurations provided within and various access/network implementations. Any suitable standards and network implementations are applicable to the edge computing concepts discussed herein. For example, many edge computing/networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

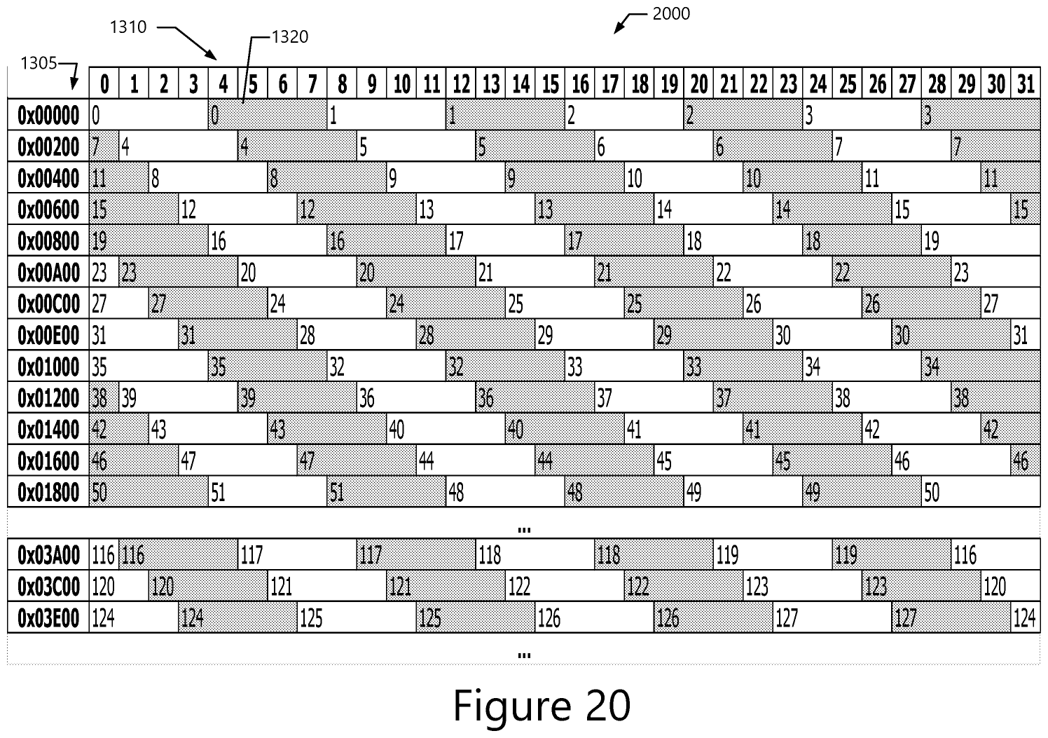

FIG. 21 shows an example edge computing system 2100, which includes a layer of processing referred to in many of the following examples as an edge cloud 2110. The edge cloud 2110 is co-located at an edge location, such as a network access node (NAN) 2140 (e.g., an access point, base station, and/or the like), a local processing hub 2150, a central office 2120, and/or may include multiple entities, devices, and equipment instances. The edge cloud 2110 is located closer to the endpoint (e.g., consumer and producer) data sources 2160 than the cloud data center 2130. The data sources 2160 include, for example, autonomous vehicles 2161, user equipment 2162, business and industrial equipment 2163, video capture devices 2164, drones 2165, smart cities and building devices 2166, sensors and IoT devices 2167, and/or the like. Compute, memory, and storage resources which are offered at the edges in the edge cloud 2110 are critical to providing ultra-low latency response times for services and functions used by the endpoint data sources 2160 as well as reduce network backhaul traffic from the edge cloud 2110 toward cloud data center 2130 thus improving energy consumption and overall network usages among other benefits. In various implementations, one or more cloud compute nodes in the cloud data center 2130 can be, or include, a compute unit 100 that implements the various temporal arbitration techniques discussed herein.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

Aspects of an edge cloud architecture covers multiple potential deployments and addresses restrictions that some network operators or service providers may have in their own infrastructures. These include variations of configurations based on edge location (e.g., because edges at a base station level may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of an appropriately arranged compute platform (e.g., x86, ARM, Nvidia or other CPU/GPU based compute hardware architecture) implemented at NANs 2140 (e.g., base stations, gateways, network routers, access points, and the like) and/or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. In another example, NANs 2140 may be augmented with compute and acceleration resources to directly process service workloads for connected user equipment, without further communicating data via backhaul networks. In another example, network management hardware of the central office 2120 may be replaced or supplemented with standardized compute hardware that performs virtualized network functions and offers compute resources for the execution of services and consumer functions for connected devices. Additionally or alternatively, an arrangement with hardware combined with virtualized functions, commonly referred to as a hybrid arrangement, can be successfully implemented. Within edge computing networks, there may be scenarios in services which the compute resource will be “moved” to the data, as well as scenarios in which the data will be “moved” to the compute resource. For example, NAN 2140 compute, acceleration, and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In some examples, resources are accessed under usage pressure from incoming streams due to multiple services utilizing the edge cloud 2110. To achieve results with low latency, the services executed within the edge cloud 2110 balance varying requirements in terms of, for example, priority (e.g., throughput or latency); Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); reliability and resiliency (e.g., some input streams need to be acted upon and the traffic routed with mission-critical reliability, where as some other input streams may be tolerate an occasional failure, depending on the application); and/or physical constraints (e.g., power, cooling, form-factor, environmental conditions, and/or the like).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to understand the impact of the SLA violation, and augment other components in the system to resume overall transaction SLA, and implement steps to remediate.

Thus, with these variations and service features in mind, edge computing within the edge cloud 2110 may provide the ability to serve and respond to multiple applications of the use cases (e.g., object tracking, video surveillance, connected cars, and/or the like) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, and the like), which cannot leverage conventional cloud computing due to latency or other limitations. With the advantages of edge computing comes the following caveats. The devices located at the edge are often resource constrained and therefore there is pressure on usage of edge resources. Typically, this is addressed through the pooling of memory and storage resources for use by multiple users (e.g., tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 2110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at various layers operating in the edge cloud, which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (e.g., “telco” or “TSP”), IoT service provider, cloud service provider (CSP), enterprise entity, or any other number of entities. Various implementations and configurations of the edge computing system may be provided dynamically, such as when orchestrated to meet service objectives.

In some examples, a client compute node (e.g., data source devices 2160) is embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 2110. As such, the edge cloud 2110 is formed from network components and functional features operated by and within edge gateway nodes, edge aggregation nodes, or other edge compute nodes among various network layers. The edge cloud 2110 thus may be embodied as any type of network that provides edge computing and/or storage resources which are proximately located to radio access network (RAN) capable endpoint devices (e.g., mobile computing devices, IoT devices, smart devices, and/or the like), which are discussed herein. In other words, the edge cloud 2110 may be envisioned as an “edge” which connects the endpoint devices and traditional network NANs that serve as an ingress point into service provider core networks, including WLAN networks (e.g., WiFi access points), mobile carrier networks (e.g., Global System for Mobile Communications (GSM) networks, Long-Term Evolution (LTE) networks, 5G/6G networks, and/or the like), while also providing storage and/or compute capabilities. Other types and forms of network access (e.g., WLAN, long-range wireless, wired networks including optical networks) may also be utilized in place of or in combination with such 3GPP carrier networks. Additionally or alternatively, the client compute node can be, or include, a compute unit 100 and/or an individual compute tile 101 that implements the various temporal arbitration techniques discussed herein.

The components of the edge cloud 2110 can include one or more compute nodes referred to as “edge compute nodes”, which can include servers, multi-tenant servers, appliance computing devices, and/or any other type of computing devices such as any of those discussed herein. For example, the edge cloud 2110 may include an edge compute node that is a self-contained electronic device including a housing, a chassis, a case or a shell. In some circumstances, the housing may be dimensioned for portability such that it can be carried by a human and/or shipped. Alternatively, it may be a smaller module suitable for installation in a vehicle for example. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Smaller, modular implementations may also include an extendible or embedded antenna arrangement for wireless communications. Example housings and/or surfaces thereof may include or connect to mounting hardware to enable attachment to structures such as buildings, telecommunication structures (e.g., poles, antenna structures, and/or the like) and/or racks (e.g., server racks, blade mounts, and/or the like). Example housings and/or surfaces thereof may support one or more sensors (e.g., temperature sensors, vibration sensors, light sensors, acoustic sensors, capacitive sensors, proximity sensors, and/or the like). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, and/or the like) and/or articulating hardware (e.g., robot arms, pivotable appendages, and/or the like). In some circumstances, the sensors may include any type of input devices such as user interface hardware (e.g., buttons, switches, dials, sliders, and/or the like). In some circumstances, example housings include output devices contained in, carried by, embedded therein and/or attached thereto. Output devices may include displays, touchscreens, lights, LEDs, speakers, I/O ports (e.g., USB), and/or the like. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The edge compute node may include hardware and software components to manage local issues such as device temperature, vibration, resource utilization, updates, power issues, physical and network security, and/or the like. Additionally or alternatively, the edge compute node can be one or more servers that include an operating system and implement a virtual computing environment. A virtual computing environment includes, for example, a hypervisor managing (e.g., spawning, deploying, destroying, and/or the like) one or more virtual machines, one or more virtualization containers, and/or the like. Such virtual computing environments provide an execution environment in which one or more applications and/or other software, code or scripts may execute while being isolated from one or more other applications, software, code or scripts. Additionally or alternatively, the edge compute node can be, or include, a compute unit 100 and/or an individual compute tile 101 that implements the various temporal arbitration techniques discussed herein. Example hardware for implementing edge compute nodes is described in conjunction with FIG. 23.

The edge compute nodes may be deployed in a multitude of arrangements. In some examples, the edge compute nodes of the edge cloud 2110 are co-located with one or more NANs 2140 and/or one or more local processing hubs 2150. Additionally or alternatively, the edge compute nodes are operated on or by the local processing hubs 2150. Additionally or alternatively, multiple NANs 2140 can be co-located or otherwise communicatively coupled with an individual edge compute node. Additionally or alternatively, an edge compute node can be co-located or operated by a radio network controller (RNC) and/or by NG-RAN functions. Additionally or alternatively, an edge compute node can be deployed at cell aggregation sites or at multi-RAT aggregation points that can be located either within an enterprise or used in public coverage areas. In a fourth example, an edge compute node can be deployed at the edge of a core network. Other deployment options are possible in other implementations

In any of the implementations discussed herein, the edge compute nodes provide a distributed computing environment for application and service hosting, and also provide storage and processing resources so that data and/or content can be processed in close proximity to subscribers (e.g., users and/or data sources 2160) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the edge compute nodes, the core network, cloud 2130, and/or application server(s), or vice versa. For example, a device application or client application operating in a data source 2160 may offload application tasks or workloads to one or more edge compute nodes. In another example, an edge compute node may offload application tasks or workloads to one or more data source devices 2160 (e.g., for distributed Ai/ML computation and/or the like).

The edge compute nodes may include or be part of an edge system (e.g., edge cloud 2110) that employs one or more edge computing technologies (ECTs). The edge compute nodes may also be referred to as “edge hosts”, “edge servers”, and/or the like The edge system (edge cloud 2110) can include a collection of edge compute nodes and edge management systems (not shown) necessary to run edge computing applications within an operator network or a subset of an operator network. The edge compute nodes are physical computer systems that may include an edge platform and/or virtualization infrastructure, and provide compute, storage, and network resources to edge computing applications. Each of the edge compute nodes are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to data source devices 2160. The VI of the edge compute nodes provide virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), ETSI GR MEC 031 v2.1.1 (2020 October), U.S. Provisional App. No. 63/003,834 filed Apr. 1, 2020 (“[US'834]”), and Int'l App. No. PCT/US2020/066969 filed on Dec. 23, 2020 (“[PCT'696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1 (2015 January), ETSI GS NFV-INF 003 V1.1.1 (2014 December), ETSI GS NFV-INF 004 V1.1.1 (2015 January), ETSI GS NFV-MAN 001 v1.1.1 (2014 December), and/or Israel et al., OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021 Dec. 23) (“[TS28533]”), the contents of each of which are hereby incorporated by reference in their entireties.

In another example implementation, the ECT is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI. Various aspects of the O-RAN architecture are described in O-RAN Architecture Description v05.00, O-RAN ALLIANCE WG1 (July 2021); O-RAN Operations and Maintenance Architecture Specification v04.00, O-RAN ALLIANCE WG1 (November 2020); O-RAN Operations and Maintenance Interface Specification v04.00, O-RAN ALLIANCE WG1 (November 2020); O-RAN Information Model and Data Models Specification v01.00, O-RAN ALLIANCE WG1 (November 2020); O-RAN Working Group 1 Slicing Architecture v05.00, O-RAN ALLIANCE WG1 (July 2021); O-RAN Working Group 2 (Non-RT RIC and AI interface WG) AI interface: Application Protocol v03.01, O-RAN ALLIANCE WG2 (March 2021); O-RAN Working Group 2 (Non RT RIC and AI interface WG) AI interface: Type Definitions v02.00, O-RAN ALLIANCE WG2 (July 2021); O-RAN Working Group 2 (Non-RT RIC and AI interface WG) AI interface: Transport Protocol v01.01, O-RAN ALLIANCE WG2 (March 2021); O-RAN Working Group 2 AI/ML workflow description and requirements v01.03 O-RAN ALLIANCE WG2 (July 2021); O-RAN Working Group 2 Non-RT RIC: Functional Architecture v01.03 O-RAN ALLIANCE WG2 (July 2021); O-RAN Working Group 3, Near-Real-time Intelligent Controller, E2 Application Protocol (E2AP) v02.00, O-RAN ALLIANCE WG3 (July 2021); O-RAN Working Group 3 Near-Real-time Intelligent Controller Architecture & E2 General Aspects and Principles v02.00, O-RAN ALLIANCE WG3 (July 2021); O-RAN Working Group 3 Near-Real-time Intelligent Controller E2 Service Model (E2SM) v02.00, O-RAN ALLIANCE WG3 (July 2021); O-RAN Working Group 3 Near-Real-time Intelligent Controller E2 Service Model (E2SM) KPM v02.00, O-RAN ALLIANCE WG3 (July 2021); O-RAN Working Group 3 Near-Real-time Intelligent Controller E2 Service Model (E2SM) RAN Function Network Interface (NI) v01.00, O-RAN ALLIANCE WG3 (February 2020); O-RAN Working Group 3 Near-Real-time Intelligent Controller E2 Service Model (E2SM) RAN Control v01.00, O-RAN ALLIANCE WG3 (July 2021); O-RAN Working Group 3 Near-Real-time Intelligent Controller Near RT RIC Architecture v02.00, O-RAN ALLIANCE WG3 (March 2021); O-RAN Fronthaul Working Group 4 Cooperative Transport Interface Transport Control Plane Specification v02.00, O-RAN ALLIANCE WG4 (March 2021); O-RAN Fronthaul Working Group 4 Cooperative Transport Interface Transport Management Plane Specification v02.00, O-RAN ALLIANCE WG4 (March 2021); O-RAN Fronthaul Working Group 4 Control, User, and Synchronization Plane Specification v07.00, O-RAN ALLIANCE WG4 (July 2021); O-RAN Fronthaul Working Group 4 Management Plane Specification v07.00, O-RAN ALLIANCE WG4 (July 2021); O-RAN Open F1/W1/E1/X2/Xn Interfaces Working Group Transport Specification v01.00, O-RAN ALLIANCE WG5 (April 2020); O-RAN Alliance Working Group 5 O1 Interface specification for O-DU v02.00, O-RAN ALLIANCE WGX (July 2021); Cloud Architecture and Deployment Scenarios for O-RAN Virtualized RAN v02.02, O-RAN ALLIANCE WG6 (July 2021); O-RAN Acceleration Abstraction Layer General Aspects and Principles v01.01, O-RAN ALLIANCE WG6 (July 2021); Cloud Platform Reference Designs v02.00, O-RAN ALLIANCE WG6 (November 2020); O-RAN O2 Interface General Aspects and Principles v01.01, O-RAN ALLIANCE WG6 (July 2021); O-RAN White Box Hardware Working Group Hardware Reference Design Specification for Indoor Pico Cell with Fronthaul Split Option 6 v02.00, O-RAN ALLIANCE WG7 (July 2021); O-RAN WG7 Hardware Reference Design Specification for Indoor Picocell (FR1) with Split Option 7-2 v03.00, O-RAN ALLIANCE WG7 (July 2021); O-RAN WG7 Hardware Reference Design Specification for Indoor Picocell (FR1) with Split Option 8 v03.00, O-RAN ALLIANCE WG7 (July 2021); O-RAN Open Transport Working Group 9 Xhaul Packet Switched Architectures and Solutions v02.00, O-RAN ALLIANCE WG9 (July 2021); O-RAN Open X-haul Transport Working Group Management interfaces for Transport Network Elements v02.00, O-RAN ALLIANCE WG9 (July 2021); O-RAN Open X-haul Transport WG9 WDM-based Fronthaul Transport v01.00, O-RAN ALLIANCE WG9 (November 2020); O-RAN Open X-haul Transport Working Group Synchronization Architecture and Solution Specification v01.00, O-RAN ALLIANCE WG9 (March 2021); O-RAN Operations and Maintenance Interface Specification v05.00, O-RAN ALLIANCE WG10 (July 2021); O-RAN Operations and Maintenance Architecture v05.00, O-RAN ALLIANCE WG10 (July 2021); O-RAN: Towards an Open and Smart RAN, O-RAN ALLIANCE, White Paper (October 2018), and U.S. application Ser. No. 17/484,743 filed on 24 Sep. 2021 (“[US′743]”) (collectively referred to as “[O-RAN]”); the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v17.2.0 (2021 Dec. 31), 3GPP TS 23.501 v17.3.0 (2021 Dec. 31), 3GPP TS 28.538 v0.4.0 (2021 Dec. 8), and U.S. application Ser. No. 17/484,719 filed on 24 Sep. 2021 (“[U.S. Ser. No. '719]”) (collectively referred to as “[SA6Edge]”), the contents of each of which are hereby incorporated by reference in their entireties. In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety. In another example implementation, the edge system operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF DRAFT-ZHU-INTAREA-GMA-14, IETA, INTAREA/Network Working Group (24 Nov. 2021) (collectively referred to as “[MAMS]”), the contents of each of which are hereby incorporated by reference in their entireties. In these implementations, an edge compute node and/or one or more cloud computing nodes/clusters may be one or more MAMS servers that includes or operates a Network Connection Manager (NCM) for downstream/DL traffic, and the client include or operate a Client Connection Manager (CCM) for upstream/UL traffic. An NCM is a functional entity that handles MAMS control messages from clients (e.g., a client that configures the distribution of data packets over available access paths and (core) network paths, and manages user-plane treatment (e.g., tunneling, encryption, and/or the like) of the traffic flows (see e.g., [MAMS]). The CCM is the peer functional element in a client (e.g., a client that handles MAMS control-plane procedures, exchanges MAMS signaling messages with the NCM, and configures the network paths at the client for the transport of user data (e.g., network packets, and/or the like) (see e.g., [MAMS]).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

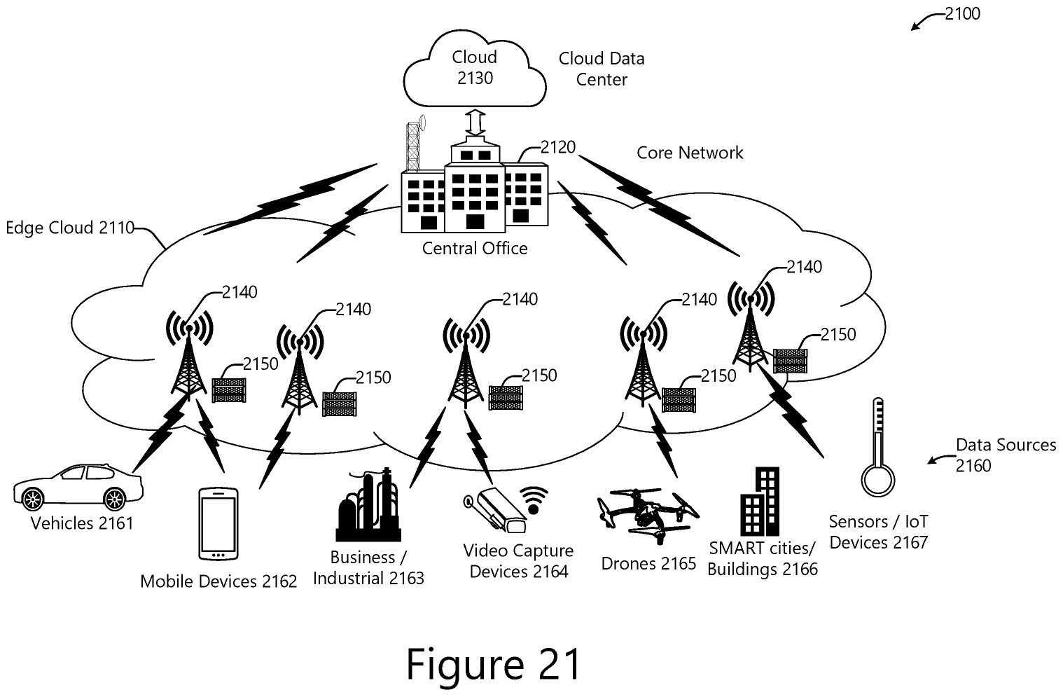

FIG. 22 illustrates an example software distribution platform 2205 to distribute software 2260, such as the example computer readable instructions 2360 of FIG. 23, to one or more devices, such as example processor platform(s) 2200 and/or example connected edge devices 2362 (see e.g., FIG. 23) and/or any of the other computing systems/devices discussed herein. The example software distribution platform 2205 may be implemented by any computer server, data facility, cloud service, and/or the like, capable of storing and transmitting software to other computing devices (e.g., third parties, the example connected edge devices 2362 of FIG. 23). Example connected edge devices may be customers, clients, managing devices (e.g., servers), third parties (e.g., customers of an entity owning and/or operating the software distribution platform 2205). Example connected edge devices may operate in commercial and/or home automation environments. In some examples, a third party is a developer, a seller, and/or a licensor of software such as the example computer readable instructions 2360 of FIG. 23. The third parties may be consumers, users, retailers, OEMs, and/or the like that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), and/or the like).

In the example of FIG. 22, the software distribution platform 2205 includes one or more servers and one or more storage devices. The storage devices store the computer readable instructions 2260, which may correspond to the example computer readable instructions 2360 of FIG. 23, as described above. The one or more servers of the example software distribution platform 2205 are in communication with a network 2210, which may correspond to any one or more of the Internet and/or any of the example networks as described herein. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2260 from the software distribution platform 2205. For example, the software 2260, which may correspond to the example computer readable instructions 2360 of FIG. 23, may be downloaded to the example processor platform(s) 2200, which is/are to execute the computer readable instructions 2260 to implement the various implementations discussed herein. In some examples, one or more servers of the software distribution platform 2205 are communicatively connected to one or more security domains and/or security devices through which requests and transmissions of the example computer readable instructions 2260 must pass. In some examples, one or more servers of the software distribution platform 2205 periodically offer, transmit, and/or force updates to the software (e.g., the example computer readable instructions 2360 of FIG. 23) to ensure improvements, patches, updates, and/or the like are distributed and applied to the software at the end user devices.

The computer readable instructions 2260 are stored on storage devices of the software distribution platform 2205 in a particular format. A format of computer readable instructions includes, but is not limited to a particular code language (e.g., Java, JavaScript, Python, C, C#, SQL, HTML, and/or the like), and/or a particular code state (e.g., uncompiled code (e.g., ASCII), interpreted code, linked code, executable code (e.g., a binary), and/or the like). In some examples, the computer readable instructions 2381, 2382, 2383 stored in the software distribution platform 2205 are in a first format when transmitted to the example processor platform(s) 2200. In some examples, the first format is an executable binary in which particular types of the processor platform(s) 2200 can execute. However, in some examples, the first format is uncompiled code that requires one or more preparation tasks to transform the first format to a second format to enable execution on the example processor platform(s) 2200. For instance, the receiving processor platform(s) 2200 may need to compile the computer readable instructions 2260 in the first format to generate executable code in a second format that is capable of being executed on the processor platform(s) 2200. In still other examples, the first format is interpreted code that, upon reaching the processor platform(s) 2200, is interpreted by an interpreter to facilitate execution of instructions.

FIG. 23 illustrates an example of components that may be present in an compute node 2350 for implementing the techniques (e.g., operations, processes, methods, and methodologies) described herein. This compute node 2350 provides a closer view of the respective components of node 2350 when implemented as or as part of a computing device (e.g., as a mobile device, a base station, server, gateway, and/or the like). The compute node 2350 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the compute node 2350, or as components otherwise incorporated within a chassis of a larger system. In some examples, the compute node 2350 may correspond to the local processing hub 2150, NAN 2140, data source devices 2160, edge compute nodes and/or edge cloud 2110 of FIG. 21; software distribution platform 2205 and/or processor platform(s) 2200 of FIG. 22; and/or any other component, device, and/or system discussed herein. The compute node 2350 may be embodied as a type of device, appliance, computer, or other “thing” capable of communicating with other edge, networking, or endpoint components. For example, compute node 2350 may be embodied as a smartphone, a mobile compute device, a smart appliance, an in-vehicle compute system (e.g., a navigation system), an edge compute node, a NAN, switch, router, bridge, hub, and/or other device or system capable of performing the described functions.

The compute node 2350 includes processing circuitry in the form of one or more processors 2352. The processor circuitry 2352 includes circuitry such as, for example, one or more processor cores and one or more of cache memory, low drop-out voltage regulators (LDOs), interrupt controllers, serial interfaces such as SPI, I²C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2352 may include one or more hardware accelerators (e.g., same or similar to acceleration circuitry 2364), which may be microprocessors, programmable processing devices (e.g., FPGA, ASIC, and/or the like), or the like. The one or more accelerators may include, for example, computer vision and/or deep learning accelerators. In some implementations, the processor circuitry 2352 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein. The processor circuitry 2352 includes a microarchitecture that is capable of executing the μenclave implementations and techniques discussed herein. The processors (or cores) 2352 may be coupled with or may include memory/storage and may be configured to execute instructions stored in the memory/storage to enable various applications or OSs to run on the platform 2350. The processors (or cores) 2352 is configured to operate application software to provide a specific service to a user of the platform 2350. Additionally or alternatively, the processor(s) 2352 may be a special-purpose processor(s)/controller(s) configured (or configurable) to operate according to the elements, features, and implementations discussed herein.

The processor circuitry 2352 may be or include, for example, one or more processor cores (CPUs), application processors, graphics processing units (GPUs), RISC processors, Acorn RISC Machine (ARM) processors, CISC processors, one or more DSPs, FPGAs, PLDs, one or more ASICs, baseband processors, radio-frequency integrated circuits (RFIC), microprocessors or controllers, multi-core processor, multithreaded processor, ultra-low voltage processor, embedded processor, an XPU, a data processing unit (DPU), an Infrastructure Processing Unit (IPU), a network processing unit (NPU), and/or any other known processing elements, or any suitable combination thereof. In some implementations, the processor circuitry 2352 may be or include the compute unit 100 of FIG. 1.

As examples, the processor(s) 2352 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 2352 may be a part of a system on a chip (SoC), System-in-Package (SiP), a multi-chip package (MCP), and/or the like, in which the processor(s) 2352 and other components are formed into a single integrated circuit, or a single package, such as the Edison™ or Galileo™ SoC boards from Intel® Corporation. Other examples of the processor(s) 2352 are mentioned elsewhere in the present disclosure. In some implementations, the processor circuitry 2352 may be or include the compute unit 100 of FIG. 1.

The processor(s) 2352 may communicate with system memory 2354 over an interconnect (IX) 2356. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). Other types of RAM, such as dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. Additionally or alternatively, the memory circuitry 2354 is or includes block addressable memory device(s), such as those based on NAND or NOR technologies (e.g., single-level cell (“SLC”), Multi-Level Cell (“MLC”), Quad-Level Cell (“QLC”), Tri-Level Cell (“TLC”), or some other NAND). In some implementations, the memory circuitry 2354 corresponds to, or includes, the memory subsystem 202 discussed previously.

To provide for persistent storage of information such as data, applications, OSs and so forth, a storage 2358 may also couple to the processor 2352 via the IX 2356. In an example, the storage 2358 may be implemented via a solid-state disk drive (SSDD) and/or high-speed electrically erasable memory (commonly referred to as “flash memory”). Other devices that may be used for the storage 2358 include flash memory cards, such as SD cards, microSD cards, eXtreme Digital (XD) picture cards, and the like, and USB flash drives. Additionally or alternatively, the memory circuitry 2354 and/or storage circuitry 2358 may be or may include memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. Additionally or alternatively, the memory circuitry 2354 and/or storage circuitry 2358 can include resistor-based and/or transistor-less memory architectures. The memory circuitry 2354 and/or storage circuitry 2358 may also incorporate three-dimensional (3D) cross-point (XPOINT) memory devices (e.g., Intel® 3D XPoint™ memory), and/or other byte addressable write-in-place NVM. The memory circuitry 2354 and/or storage circuitry 2358 may refer to the die itself and/or to a packaged memory product.

In low power implementations, the storage 2358 may be on-die memory or registers associated with the processor 2352. However, in some examples, the storage 2358 may be implemented using a micro hard disk drive (HDD). Further, any number of new technologies may be used for the storage 2358 in addition to, or instead of, the technologies described, such resistance change memories, phase change memories, holographic memories, or chemical memories, among others.

Computer program code for carrying out operations of the present disclosure (e.g., computational logic and/or instructions 2381, 2382, 2383) may be written in any combination of one or more programming languages, including an object oriented programming language such as Python, Ruby, Scala, Smalltalk, Java™, C++, C#, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code 2381, 2382, 2383 for carrying out operations of the present disclosure may also be written in any combination of the programming languages discussed herein. The program code may execute entirely on the system 2350, partly on the system 2350, as a stand-alone software package, partly on the system 2350 and partly on a remote computer or entirely on the remote computer or server. In the latter scenario, the remote computer may be connected to the system 2350 through any type of network, including a LAN or WAN, or the connection may be made to an external computer (e.g., through the Internet using an Internet Service Provider (ISP)).

In an example, the instructions 2381, 2382, 2383 on the processor circuitry 2352 (separately, or in combination with the instructions 2381, 2382, 2383) may configure execution or operation of a trusted execution environment (TEE) 2390. The TEE 2390 operates as a protected area accessible to the processor circuitry 2302 to enable secure access to data and secure execution of instructions. In some embodiments, the TEE 2390 may be a physical hardware device that is separate from other components of the system 2350 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

Additionally or alternatively, the TEE 2390 may be implemented as secure enclaves (or “enclaves”), which are isolated regions of code and/or data within the processor and/or memory/storage circuitry of the compute node 2350. Only code executed within a secure enclave may access data within the same secure enclave, and the secure enclave may only be accessible using the secure application (which may be implemented by an application processor or a tamper-resistant microcontroller). Various implementations of the TEE 2390, and an accompanying secure area in the processor circuitry 2352 or the memory circuitry 2354 and/or storage circuitry 2358 may be provided, for instance, through use of Intel® Software Guard Extensions (SGX), ARM® TrustZone®, Keystone Enclaves, Open Enclave SDK, and/or the like. Other aspects of security hardening, hardware roots-of-trust, and trusted or protected operations may be implemented in the device 2300 through the TEE 2390 and the processor circuitry 2352. Additionally or alternatively, the memory circuitry 2354 and/or storage circuitry 2358 may be divided into isolated user-space instances such as virtualization/OS containers, partitions, virtual environments (VEs), and/or the like. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 2304 and/or storage circuitry 2308 may be divided into one or more trusted memory regions for storing applications or software modules of the TEE 2390.

The OS stored by the memory circuitry 2354 and/or storage circuitry 2358 is software to control the compute node 2350. The OS may include one or more drivers that operate to control particular devices that are embedded in the compute node 2350, attached to the compute node 2350, and/or otherwise communicatively coupled with the compute node 2350. Example OSs include consumer-based operating systems (e.g., Microsoft® Windows® 10, Google® Android®, Apple® macOS®, Apple® iOS®, KaiOS™ provided by KaiOS Technologies Inc., Unix or a Unix-like OS such as Linux, Ubuntu, or the like), industry-focused OSs such as real-time OS (RTOS) (e.g., Apache® Mynewt, Windows® IoT®, Android Things®, Micrium® Micro-Controller OSs (“MicroC/OS” or “μC/OS”), VxWorks®, FreeRTOS, and/or the like), hypervisors (e.g., Xen® Hypervisor, Real-Time Systems® RTS Hypervisor, Wind River Hypervisor, VMWare® vSphere® Hypervisor, and/or the like), and/or the like. The OS can invoke alternate software to facilitate one or more functions and/or operations that are not native to the OS, such as particular communication protocols and/or interpreters. Additionally or alternatively, the OS instantiates various functionalities that are not native to the OS. In some examples, OSs include varying degrees of complexity and/or capabilities. In some examples, a first OS on a first compute node 2350 may be the same or different than a second OS on a second compute node 2350. For instance, the first OS may be an RTOS having particular performance expectations of responsivity to dynamic input conditions, and the second OS can include GUI capabilities to facilitate end-user I/O and the like.

The storage 2358 may include instructions 2383 in the form of software, firmware, or hardware commands to implement the techniques described herein. Although such instructions 2383 are shown as code blocks included in the memory 2354 and the storage 2358, any of the code blocks may be replaced with hardwired circuits, for example, built into an application specific integrated circuit (ASIC), FPGA memory blocks, and/or the like. In an example, the instructions 2381, 2382, 2383 provided via the memory 2354, the storage 2358, or the processor 2352 may be embodied as a non-transitory, machine-readable medium 2360 including code to direct the processor 2352 to perform electronic operations in the compute node 2350. The processor 2352 may access the non-transitory, machine-readable medium 2360 (also referred to as “computer readable medium 2360” or “CRM 2360”) over the IX 2356. For instance, the non-transitory, CRM 2360 may be embodied by devices described for the storage 2358 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, CRM 2360 may include instructions to direct the processor 2352 to perform a specific sequence or flow of actions, for example, as described with respect to the flowchart(s) and/or block diagram(s) of operations and functionality depicted herein.

The components of edge computing device 2350 may communicate over an interconnect (IX) 2356. The IX 2356 may represent any suitable type of connection or interface such as, for example, metal or metal alloys (e.g., copper, aluminum, and/or the like), fiber, and/or the like. The IX 2356 may include any number of IX, fabric, and/or interface technologies, including instruction set architecture (ISA), extended ISA (eISA), Inter-Integrated Circuit (I2C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX technology, RapidIO™ IX, Coherent Accelerator Processor Interface (CAPI), OpenCAPI, cache coherent interconnect for accelerators (CCIX), Gen-Z Consortium IXs, HyperTransport IXs, NVLink provided by NVIDIA®, a Time-Trigger Protocol (TTP) system, a FlexRay system, PROFIBUS, ARM® Advanced eXtensible Interface (AXI), ARM® Advanced Microcontroller Bus Architecture (AMBA) IX, HyperTransport, Infinity Fabric (IF), and/or any number of other IX technologies. The IX 2356 may be a proprietary bus, for example, used in a SoC based system. Additionally or alternatively, the IX 2356 may be a suitable compute fabric such as the compute fabric circuitry 2450 discussed infra with respect to FIG. 24.

The IX 2356 couples the processor 2352 to communication circuitry 2366 for communications with other devices, such as a remote server (not shown) and/or the connected edge devices 2362. The communication circuitry 2366 is a hardware element, or collection of hardware elements, used to communicate over one or more networks (e.g., cloud 2363) and/or with other devices (e.g., edge devices 2362). Communication circuitry 2366 includes modem circuitry 2366x may interface with application circuitry of compute node 2350 (e.g., a combination of processor circuitry 2302 and CRM 2360) for generation and processing of baseband signals and for controlling operations of the transceivers (TRx) 2366y and 2366z. The modem circuitry 2366x may handle various radio control functions that enable communication with one or more (R)ANs via the TRxs 2366y and 2366z according to one or more wireless communication protocols and/or RATs. The modem circuitry 2366x may include circuitry such as, but not limited to, one or more single-core or multi-core processors (e.g., one or more baseband processors) or control logic to process baseband signals received from a receive signal path of the TRxs 2366y, 2366z, and to generate baseband signals to be provided to the TRxs 2366y, 2366z via a transmit signal path. The modem circuitry 2366x may implement a real-time OS (RTOS) to manage resources of the modem circuitry 2366x, schedule tasks, perform the various radio control functions, process the transmit/receive signal paths, and the like. In some implementations, the modem circuitry 2366x includes a μarch that is capable of executing the μenclave implementations and techniques discussed herein.

The TRx 2366y may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2362. For example, a wireless local area network (WLAN) unit may be used to implement Wi-Fi® communications in accordance with a [IEEE802] standard (e.g., [IEEE80211] and/or the like). In addition, wireless wide area communications, e.g., according to a cellular or other wireless wide area protocol, may occur via a wireless wide area network (WWAN) unit.

The TRx 2366y (or multiple transceivers 2366y) may communicate using multiple standards or radios for communications at a different range. For example, the compute node 2350 may communicate with relatively close devices (e.g., within about 10 meters) using a local transceiver based on BLE, or another low power radio, to save power. More distant connected edge devices 2362 (e.g., within about 50 meters) may be reached over ZigBee® or other intermediate power radios. Both communications techniques may take place over a single radio at different power levels or may take place over separate transceivers, for example, a local transceiver using BLE and a separate mesh transceiver using ZigBee®.

A TRx 2366z (e.g., a radio transceiver) may be included to communicate with devices or services in the edge cloud 2363 via local or wide area network protocols. The TRx 2366z may be an LPWA transceiver that follows [IEEE802154] or IEEE 802.15.4g standards, among others. The edge computing node 2363 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used. Any number of other radio communications and protocols may be used in addition to the systems mentioned for the TRx 2366z, as described herein. For example, the TRx 2366z may include a cellular transceiver that uses spread spectrum (SPA/SAS) communications for implementing high-speed communications. Further, any number of other protocols may be used, such as WiFi® networks for medium speed communications and provision of network communications. The TRx 2366z may include radios that are compatible with any number of 3GPP specifications, such as LTE and 5G/NR communication systems.

A network interface controller (NIC) 2368 may be included to provide a wired communication to nodes of the edge cloud 2363 or to other devices, such as the connected edge devices 2362 (e.g., operating in a mesh, fog, and/or the like). The wired communication may provide an Ethernet connection (see e.g., Ethernet (e.g., IEEE Standard for Ethernet, IEEE Std 802.3-2018, pp. 1-5600 (31 Aug. 2018) (“[IEEE8023]”)) or may be based on other types of networks, such as Controller Area Network (CAN), Local Interconnect Network (LIN), DeviceNet, ControlNet, Data Highway+, or PROFINET, among many others. In some implementations, the NIC d68 may be an Ethernet controller (e.g., a Gigabit Ethernet Controller or the like), a SmartNIC, Intelligent Fabric Processor(s) (IFP(s)). An additional NIC 2368 may be included to enable connecting to a second network, for example, a first NIC 2368 providing communications to the cloud over Ethernet, and a second NIC 2368 providing communications to other devices over another type of network.

Given the variety of types of applicable communications from the device to another component or network, applicable communications circuitry used by the device may include or be embodied by any one or more of components 2364, 2366, 2368, or 2370. Accordingly, in various examples, applicable means for communicating (e.g., receiving, transmitting, and/or the like) may be embodied by such communications circuitry.

The compute node 2350 can include or be coupled to acceleration circuitry 2364, which may be embodied by one or more hardware accelerators, a neural compute stick, neuromorphic hardware, FPGAs, GPUs, SoCs (including programmable SoCs), vision processing units (VPUs), digital signal processors, dedicated ASICs, programmable ASICs, PLDs (e.g., CPLDs and/or HCPLDs), DPUs, IPUs, NPUs, and/or other forms of specialized processors or circuitry designed to accomplish one or more specialized tasks. Additionally or alternatively, the acceleration circuitry 2364 is embodied as one or more XPUs. In some implementations, an XPU is a multi-chip package including multiple chips stacked like tiles into an XPU, where the stack of chips includes any of the processor types discussed herein. Additionally or alternatively, an XPU is implemented by a heterogeneous computing system including multiple types of processor circuitry (e.g., one or more FPGAs, one or more CPUs, one or more GPUs, one or more DSPs, and/or the like, and/or a combination thereof) and application programming interface(s) (API(s)) that may assign computing task(s) to whichever one(s) of the multiple types of the processing circuitry is/are best suited to execute the computing task(s). In any of these implementations, the tasks may include AI/ML tasks (e.g., training, inferencing/prediction, classification, and the like), visual data processing, network data processing, infrastructure function management, object detection, rule analysis, or the like. In FPGA-based implementations, the acceleration circuitry 2364 may comprise logic blocks or logic fabric and other interconnected resources that may be programmed (configured) to perform various functions, such as the procedures, methods, functions, and/or the like discussed herein. In such implementations, the acceleration circuitry 2364 may also include memory cells (e.g., EPROM, EEPROM, flash memory, static memory (e.g., SRAM, anti-fuses, and/or the like) used to store logic blocks, logic fabric, data, and/or the like in LUTs and the like. In some implementations, the acceleration circuitry 2364 may be or include the compute unit 100 of FIG. 1.

In some implementations, the acceleration circuitry 2364 and/or the processor circuitry 2352 can be or include may be a cluster of artificial intelligence (AI) GPUs, tensor processing units (TPUs) developed by Google® Inc., Real AI Processors (RAPs™) provided by AlphaICs®, Intel® Nervana™ Neural Network Processors (NNPs), Intel® Movidius™ Myriad™ X Vision Processing Units (VPUs), NVIDIA® PX™ based GPUs, the NM500 chip provided by General Vision®, Tesla® Hardware 3 processor, an Adapteva® Epiphany™ based processor, and/or the like. Additionally or alternatively, the acceleration circuitry 2364 and/or the processor circuitry 2352 can be implemented as AI accelerating co-processor(s), such as the Hexagon 685 DSP provided by Qualcomm®, the PowerVR 2NX Neural Net Accelerator (NNA) provided by Imagination Technologies Limited®, the Apple® Neural Engine core, a Neural Processing Unit (NPU) within the HiSilicon Kirin 970 provided by Huawei®, and/or the like.

The IX 2356 also couples the processor 2352 to an external interface 2370 that is used to connect additional devices or subsystems. In some implementations, the interface 2370 can include one or more input/output (I/O) controllers. Examples of such I/O controllers include integrated memory controller (IMC), memory management unit (MMU), input-output MMU (IOMMU), sensor hub, General Purpose I/O (GPIO) controller, PCIe endpoint (EP) device, direct media interface (DMI) controller, Intel® Flexible Display Interface (FDI) controller(s), VGA interface controller(s), Peripheral Component Interconnect Express (PCIe) controller(s), universal serial bus (USB) controller(s), eXtensible Host Controller Interface (xHCI) controller(s), Enhanced Host Controller Interface (EHCI) controller(s), Serial Peripheral Interface (SPI) controller(s), Direct Memory Access (DMA) controller(s), hard drive controllers (e.g., Serial AT Attachment (SATA) host bus adapters/controllers, Intel® Rapid Storage Technology (RST), and/or the like), Advanced Host Controller Interface (AHCI), a Low Pin Count (LPC) interface (bridge function), Advanced Programmable Interrupt Controller(s) (APIC), audio controller(s), SMBus host interface controller(s), UART controller(s), and/or the like. Some of these controllers may be part of, or otherwise applicable to the memory circuitry 2354, storage circuitry 2358, and/or IX 2356 as well. The additional/external devices may include sensors 2372, actuators 2374, and positioning circuitry 2345.

The sensor circuitry 2372 includes devices, modules, or subsystems whose purpose is to detect events or changes in its environment and send the information (sensor data) about the detected events to some other a device, module, subsystem, and/or the like. Examples of such sensors 2372 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node 2350); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

The actuators 2374, allow platform 2350 to change its state, position, and/or orientation, or move or control a mechanism or system. The actuators 2374 comprise electrical and/or mechanical devices for moving or controlling a mechanism or system, and converts energy (e.g., electric current or moving air and/or liquid) into some kind of motion. The actuators 2374 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2374 may include one or more electromechanical devices such as pneumatic actuators, hydraulic actuators, electromechanical switches including electromechanical relays (EMRs), motors (e.g., DC motors, stepper motors, servomechanisms, and/or the like), power switches, valve actuators, wheels, thrusters, propellers, claws, clamps, hooks, audible sound generators, visual warning devices, and/or other like electromechanical components. The platform 2350 may be configured to operate one or more actuators 2374 based on one or more captured events and/or instructions or control signals received from a service provider and/or various client systems.

The positioning circuitry 2345 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and/or the like), or the like. The positioning circuitry 2345 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 2345 may include a Micro-Technology for Positioning, Navigation, and Timing (Micro-PNT) IC that uses a master timing clock to perform position tracking/estimation without GNSS assistance. The positioning circuitry 2345 may also be part of, or interact with, the communication circuitry 2366 to communicate with the nodes and components of the positioning network. The positioning circuitry 2345 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS). In some implementations, the positioning circuitry 2345 is, or includes an INS, which is a system or device that uses sensor circuitry 2372 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 2350 without the need for external references.

In some optional examples, various input/output (I/O) devices may be present within or connected to, the compute node 2350, which are referred to as input circuitry 2386 and output circuitry 2384 in FIG. 23. The input circuitry 2386 and output circuitry 2384 include one or more user interfaces designed to enable user interaction with the platform 2350 and/or peripheral component interfaces designed to enable peripheral component interaction with the platform 2350. Input circuitry 2386 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 2384 may be included to show information or otherwise convey information, such as sensor readings, actuator position(s), or other like information. Data and/or graphics may be displayed on one or more user interface components of the output circuitry 2384. Output circuitry 2384 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and/or the like), with the output of characters, graphics, multimedia objects, and the like being generated or produced from the operation of the platform 2350. The output circuitry 2384 may also include speakers or other audio emitting devices, printer(s), and/or the like. Additionally or alternatively, the sensor circuitry 2372 may be used as the input circuitry 2384 (e.g., an image capture device, motion capture device, or the like) and one or more actuators 2374 may be used as the output device circuitry 2384 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and/or the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2376 may power the compute node 2350, although, in examples in which the compute node 2350 is mounted in a fixed location, it may have a power supply coupled to an electrical grid, or the battery may be used as a backup or for temporary capabilities. The battery 2376 may be a lithium ion battery, or a metal-air battery, such as a zinc-air battery, an aluminum-air battery, a lithium-air battery, and the like.

A battery monitor/charger 2378 may be included in the compute node 2350 to track the state of charge (SoCh) of the battery 2376, if included. The battery monitor/charger 2378 may be used to monitor other parameters of the battery 2376 to provide failure predictions, such as the state of health (SoH) and the state of function (SoF) of the battery 2376. The battery monitor/charger 2378 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 2378 may communicate the information on the battery 2376 to the processor 2352 over the IX 2356. The battery monitor/charger 2378 may also include an analog-to-digital (ADC) converter that enables the processor 2352 to directly monitor the voltage of the battery 2376 or the current flow from the battery 2376. The battery parameters may be used to determine actions that the compute node 2350 may perform, such as transmission frequency, mesh network operation, sensing frequency, and the like.

A power block 2380, or other power supply coupled to a grid, may be coupled with the battery monitor/charger 2378 to charge the battery 2376. In some examples, the power block 2380 may be replaced with a wireless power receiver to obtain the power wirelessly, for example, through a loop antenna in the compute node 2350. A wireless battery charging circuit, such as an LTC4020 chip from Linear Technologies of Milpitas, Calif., among others, may be included in the battery monitor/charger 2378. The specific charging circuits may be selected based on the size of the battery 2376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The example of FIG. 23 is intended to depict a high-level view of components of a varying device, subsystem, or arrangement of an edge computing node. However, in other implementations, some of the components shown may be omitted, additional components may be present, and a different arrangement of the components shown may occur in other implementations. Further, these arrangements are usable in a variety of use cases and environments, including those discussed below (e.g., a mobile device in industrial compute for smart city or smart factory, among many other examples).

FIG. 24 depicts an example of an infrastructure processing unit (IPU) 2400. Different examples of IPUs 2400 discussed herein are capable of supporting one or more processors (such as any of those discussed herein) connected to the IPUs 2400, and enable improved performance, management, security and coordination functions between entities (e.g., cloud service providers (CSPs)), and enable infrastructure offload and/or communications coordination functions. As discussed infra, IPUs 2400 may be integrated with smart NICs and/or storage or memory (e.g., on a same die, system on chip (SoC), or connected dies) that are located at on-premises systems, NANs (e.g., base stations, access points, gateways, network appliances, and/or the like), neighborhood central offices, and so forth. In various implementations, the IPU 2400, or individual components of the IPU 2400, may be or include the compute unit 100 of FIG. 1. Different examples of one or more IPUs 2400 discussed herein can perform application and/or functionality including any number of microservices, where each microservice runs in its own process and communicates using protocols (e.g., an HTTP resource API, message service, gRPC, and/or the like). Microservices can be independently deployed using centralized management of these services. A management system may be written in different programming languages and use different data storage technologies.

Furthermore, one or more IPUs 2400 can execute platform management, networking stack processing operations, security (crypto) operations, storage software, identity and key management, telemetry, logging, monitoring and service mesh (e.g., control how different microservices communicate with one another). The IPU 2400 can access an XPU to offload performance of various tasks. For instance, an IPU 2400 exposes XPU, storage, memory, and processor resources and capabilities as a service that can be accessed by other microservices for function composition. This can improve performance and reduce data movement and latency. An IPU 2400 can perform capabilities such as those of a router, load balancer, firewall, TCP/reliable transport, a service mesh (e.g., proxy or API gateway), security, data transformation, authentication, quality of service (QoS), security, telemetry measurement, event logging, initiating and managing data flows, data placement, or job scheduling of resources on an XPU, storage, memory, and/or processor circuitry.

In the example of FIG. 24, the IPU 2400 includes or otherwise accesses secure resource management (SRM) circuitry 2402, network interface controller (NIC) circuitry 2404, security and root of trust (SRT) circuitry 2406, resource composition circuitry 2408, timestamp management (TSM) circuitry 2410, memory and storage circuitry 2412, processing circuitry 2414, accelerator circuitry 2416, and/or translator circuitry 2418. Any number and/or combination of other structure(s) can be used such as, but not limited to, compression and encryption (C&E) circuitry 2420; memory management and translation unit (MMTU) circuitry 2422; compute fabric data switching (CFDS) circuitry 2424; security policy enforcement (SPE) circuitry 2426, device virtualization (DV) circuitry 2428; telemetry, tracing, logging, and monitoring (TTLM) circuitry 2430, quality of service (QoS) circuitry 2432, searching circuitry 2434, network function (NF) circuitry 2436 (e.g., operating as a router, switch (e.g., software-defined networking (SDN) switch), firewall, load balancer, network address translator (NAT), and/or any other suitable NF such as any of those discussed herein); reliable transporting, ordering, retransmission, congestion control (RTORCC) circuitry 2438; and high availability, fault handling and migration (HAFHM) circuitry 2440 as shown by FIG. 24. Different examples can use one or more structures (components) of the example IPU 2400 together or separately. For example, C&E circuitry 2420 can be used as a separate service or chained as part of a data flow with vSwitch and packet encryption.

In some examples, IPU 2400 includes programmable circuitry 2470 structured to receive commands from processor circuitry 2414 (e.g., CPU, GPU, XPUs, DPUs, NPUs, and/or the like) and/or an application or service via an API and perform commands/tasks on behalf of the processor circuitry 2414 or other requesting element, including workload management and offload or accelerator operations. The programmable circuitry 2470 can include any number of field programmable gate arrays (FPGAs), programmable ASICs, programmable SoCs, CLDs, DSPs, and/or other programmable devices configured and/or otherwise structures to perform any operations of any IPU 2400 described herein.

Example compute fabric circuitry 2450 provides connectivity to a local host or device (e.g., server or device such as compute resources, memory resources, storage resources, and/or the like). Connectivity with a local host or device or smartNIC or another IPU is, in some examples, provided using one or more of PCI (or variants thereof such as PCIe and/or the like), ARM AXI, Intel® QPI, Intel® UPI, Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. In some examples, the compute fabric circuitry 2450 may implement any of the IX technologies discussed previously with respect to IX 2356. Different examples of the host connectivity provide symmetric memory and caching to enable equal peering between CPU, XPU, DPU, and IPU (e.g., via CXL.cache and CXL.mem).

Example media interfacing circuitry 2460 provides connectivity to a remote smartNIC, another IPU (e.g., another IPU 2400 or the like), and/or service via a network medium or fabric. This can be provided over any type of network media (e.g., wired or wireless) and/or using any suitable protocol (e.g., Ethernet, InfiniBand, Fiber channel, ATM, and/or the like).

In some examples, instead of the server/CPU being the primary component managing IPU 2400, IPU 2400 is a root of a system (e.g., rack of servers or data center) and manages compute resources (e.g., CPU, XPU, storage, memory, other IPUs, and so forth) in the IPU 2400 and outside of the IPU 2400. Different operations of an IPU are described below.

In some examples, the IPU 2400 performs orchestration to decide which hardware or software is to execute a workload based on available resources (e.g., services and devices) and considers service level agreements and latencies, to determine whether resources (e.g., CPU, XPU, storage, memory, and/or the like) are to be allocated from the local host or from a remote host or pooled resource. In examples when the IPU 2400 is selected to perform a workload, secure resource managing circuitry 2402 offloads work to a CPU, XPU, or other device or platform, and the IPU 2400 accelerates connectivity of distributed runtimes, reduce latency, and increases reliability.

In some examples, SRM circuitry 2402 runs a service mesh to decide what resource is to execute workload, and provide for L7 (application layer) and remote procedure call (RPC) traffic to bypass kernel altogether so that a user space application can communicate directly with the example IPU 2400 (e.g., IPU 2400 and application can share a memory space). In some examples, a service mesh is a configurable, low-latency infrastructure layer designed to handle communication among application microservices using application programming interfaces (APIs) (e.g., over RPCs and/or the like). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern. In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL. In some cases, the example IPU 2400 dynamically selects itself to run a given workload (e.g., microservice) within a composable infrastructure including an IPU, XPU, CPU, storage, memory, and other devices in a node.

In some examples, communications transit through media interfacing circuitry 2460 of the example IPU 2400 through a NIC/smartNIC (for cross node communications) or loopback back to a local service on the same host. Communications through the example media interfacing circuitry 2460 of the example IPU 2400 to another IPU can then use shared memory support transport between XPUs switched through the local IPUs. Use of IPU-to-IPU communication can reduce latency and jitter through ingress scheduling of messages and work processing based on service level objective (SLO).

For example, for a request to a database application that requires a response, the example IPU 2400 prioritizes its processing to minimize the stalling of the requesting application. In some examples, the IPU 2400 schedules the prioritized message request issuing the event to execute a SQL query database and the example IPU constructs microservices that issue SQL queries and the queries are sent to the appropriate devices or services.

FIG. 25 depicts an example systems 2500a and 2500b. System 2500a includes a compute server 2510a, storage server 2511a, and machine learning (ML) server 2512a. The compute server 2510a includes one or more CPUs 2550 (which may be the same or similar as the processor circuitry 2352 of FIG. 23) and a network interface controller (NIC) 2568 (which may be the same or similar as the network interface circuitry 2368 of FIG. 23). The storage server 2511a includes a CPU 2550, a NIC 2568, and one or more solid state drives (SSDs) 2560 (which may be the same or similar as the NTCRM 2360 of FIG. 23). The ML server 2512a includes a CPU 2550, a NIC 2568, and one or more GPUs 2552. In system 2500a, workload execution 2503 is/are provided on or by CPUs 2550 and GPUs 2552 of the servers 2510a, 2511a, 2512a. System 2500a includes security control point (SCP) 2501, which delivers security and trust within individual CPUs 2550.

System 2500b includes a compute server 2510b, storage server 2511b, ML server 2512b, an inference server 2520, flexible server 2521, and multi-acceleration server 2522. The compute server 2510b includes one or more CPUs 2550 and an IPU 2524 (which may be the same or similar as the IPU 2400 of FIG. 24). The storage server 2511b includes an ASIC 2551, an IPU 2524, and one or more SSDs 2560. The ML server 2512b includes one or more GPUs 2552 and an IPU 2524. The inference server 2520 includes an IPU 2524 and one or more inference accelerators 2564 (which may be the same or similar as the acceleration circuitry 2364 of FIG. 23). The flexible server 2521 includes an IPU 2524 and a one or more FPGAs 2565 (which may be the same or similar as FPGAs discussed previously). The multi-acceleration server 2522 includes an IPU 2524, one or more FPGAs 2565, and one or more inference accelerators 2564. System 2500b involves rebalancing the SCPs 2501 as cloud service providers (CSPs) absorb infrastructure workloads 2503. The system 2500b rebalances the SCPs 2501 to IPUs 2524 from CPUs 2550 to handle workload execution 2503 by CSPs. Additionally, infrastructure security and SCPs 2501 move into the IPUs 2524, and the SCPs 2501 provide end-to-end security. Various elements of the IPU 2400 of FIG. 24 can be used to provide SCPs 2501 such as, for example, the SRM circuitry 2402 and/or the SRT circuitry 2406.

FIG. 26 illustrates an example neural network (NN) 2600, which may be suitable for use by one or more of the computing systems (or subsystems) of the various implementations discussed herein, implemented in part by a HW accelerator, and/or the like. The NN 2600 may be deep neural network (DNN) used as an artificial brain of a compute node or network of compute nodes to handle very large and complicated observation spaces. Additionally or alternatively, the NN 2600 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or RL.

The NN 2600 may encompass a variety of ML techniques where a collection of connected artificial neurons 2610 that (loosely) model neurons in a biological brain that transmit signals to other neurons/nodes 2610. The neurons 2610 may also be referred to as nodes 2610, processing elements (PEs) 2610, or the like. The connections 2620 (or edges 2620) between the nodes 2610 are (loosely) modeled on synapses of a biological brain and convey the signals between nodes 2610. Note that not all neurons 2610 and edges 2620 are labeled in FIG. 26 for the sake of clarity.

Each neuron 2610 has one or more inputs and produces an output, which can be sent to one or more other neurons 2610 (the inputs and outputs may be referred to as “signals”). Inputs to the neurons 2610 of the input layer Lₓ can be feature values of a sample of external data (e.g., input variables xᵢ). For example, the inputs to the neurons 2610 can include tensor elements of the tensor 1100 and/or tensor 12b00 of FIGS. 11 and 12b discussed previously. The input variables xᵢ can be set as a vector or tensor containing relevant data (e.g., observations, ML features, and/or the like). The inputs to hidden units 2610 of the hidden layers Lₐ, L_{b}, and L_{c} may be based on the outputs of other neurons 2610. The outputs of the final output neurons 2610 of the output layer L_{y} (e.g., output variables yᵢ) include predictions, inferences, and/or accomplish a desired/configured task. The output variables yᵢ may be in the form of determinations, inferences, predictions, and/or assessments. Additionally or alternatively, the output variables yᵢ can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 2610 may have a threshold such that a signal is sent only if the aggregate signal crosses that threshold. A node 2610 may include an activation function, which defines the output of that node 2610 given an input or set of inputs. Additionally or alternatively, a node 2610 may include a propagation function that computes the input to a neuron 2610 from the outputs of its predecessor neurons 2610 and their connections 2620 as a weighted sum. A bias term can also be added to the result of the propagation function.

The NN 2600 also includes connections 2620, some of which provide the output of at least one neuron 2610 as an input to at least another neuron 2610. Each connection 2620 may be assigned a weight that represents its relative importance. The weights may also be adjusted as learning proceeds. The weight increases or decreases the strength of the signal at a connection 2620.

The neurons 2610 can be aggregated or grouped into one or more layers L where different layers L may perform different transformations on their inputs. In FIG. 26, the NN 2600 comprises an input layer Lₓ, one or more hidden layers Lₐ, L_{b}, and L_{c}, and an output layer L_{y} (where a, b, c, x, and y may be numbers), where each layer L comprises one or more neurons 2610. Signals travel from the first layer (e.g., the input layer L₁), to the last layer (e.g., the output layer L_{y}), possibly after traversing the hidden layers Lₐ, L_{b}, and L_{c} multiple times. In FIG. 26, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yᵢ (where j=1, . . . , p′, where p′ is a number that is the same or different than p). In the example of FIG. 26, for simplicity of illustration, there are only three hidden layers Lₐ, L_{b}, and L_{c} in the NN 2600, however, the NN 2600 may include many more (or fewer) hidden layers Lₐ, L_{b}, and L_{c} than are shown.

### 3. Example Implementations

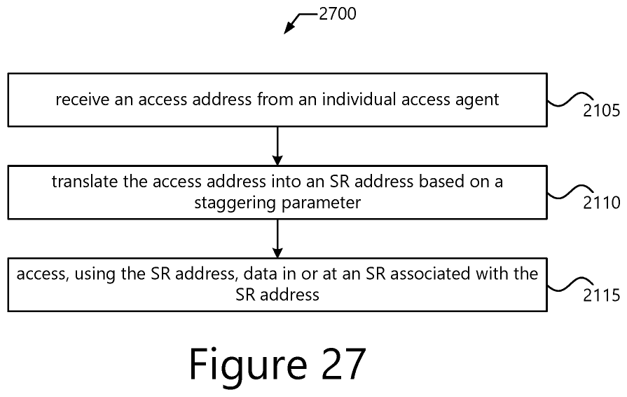

FIG. 27 shows an example temporal access arbitration process 2700, which may be performed by access arbitration circuitry (e.g., arbiter 302) of a shared memory system (e.g., memory subsystem 202) that is arranged into a set of SRs (e.g., SRs 310, 610, 1310). Process 2700 begins at operation 2701 where the access arbitration circuitry receives, from an individual access agent (e.g., access agent 605, processing unit 201, or the like) of the plurality of access agents, an access address (e.g., agent address a_{y}, access address 1500, and/or routing address 1510) for a memory transaction, wherein the access address is assigned to at least one SR in the set of SRs. At operation 2702, the access arbitration circuitry translates the access address into an SR address (e.g., SR address s_{y} and/or access address 1501, and/or physical routing address 1511) based on a staggering parameter (e.g., staggering parameter 1420). The staggering parameter is based on a number of bytes by which individual SR addresses of the set of SRs are staggered in the shared memory system. At operation 2703, the access arbitration circuitry uses the SR address to access data in or at an SR associated with the at least one SR. The access can include storing or writing data to the at least one SR, or the access can include reading or obtaining data stored in the at least one SR and providing that data to the access agent. After operation 2703, process 2700 may end or repeat as necessary.

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method of operating access arbitration circuitry of a shared memory system that is shared among a plurality of access agents, wherein the shared memory system is arranged into a set of shared resources (SRs), and the method comprising: receiving, from an individual access agent of the plurality of access agents, an access address for a memory transaction, wherein the access address is assigned to at least one SR in the set of SRs; translating the access address into an SR address based on a staggering parameter, wherein the staggering parameter is based on a number of bytes by which individual SR addresses of the set of SRs are staggered in the shared memory system; and accessing data stored in the at least one SR using the SR address.

Example 2 includes the method of example 1 and/or some other example(s) herein, wherein the staggering parameter is an offset by which the individual SR addresses are staggered in the shared memory system.

Example 3 includes the method of examples 1-2 and/or some other example(s) herein, wherein the access address includes an agent address field, wherein the agent address field includes an agent address value, and the agent address value is a virtual address for the at least one SR in an access agent address space.

Example 4 includes the method of example 3 and/or some other example(s) herein, wherein the access address includes a stagger seed field, wherein the stagger seed field includes an stagger seed value, and the stagger seed value is used for the translating.

Example 5 includes the method of example 4 and/or some other example(s) herein, wherein the translating includes: performing a bitwise operation on the agent address value using the stagger seed value to obtain the SR address.

Example 6 includes the method of example 5 and/or some other example(s) herein, wherein the performing the bitwise operation includes: performing a binary shift left operation based on a difference between a number of bits of the agent address field and the stagger parameter.

Example 7 includes the method of example 6 and/or some other example(s) herein, wherein the stagger parameter is a number of bits of the stagger seed field.

Example 8 includes the method of example 5 and/or some other example(s) herein, wherein the performing the bitwise operation includes: adding the stagger seed value to the agent address value to obtain an SR index value.

Example 9 includes the method of example 8 and/or some other example(s) herein, wherein the method includes: inserting the SR index value into the agent address field to obtain the SR address.

Example 10 includes the method of examples 8-9 and/or some other example(s) herein, wherein the stagger parameter is a number of bits of the stagger seed value.

Example 11 includes the method of examples 1-10 and/or some other example(s) herein, wherein data stored in the shared memory system is staggered by half of a number of SRs in the set of SRs when the staggering parameter is one.

Example 12 includes the method of examples 1-10 and/or some other example(s) herein, wherein data stored in the shared memory system is staggered by a quarter of a number of SRs in the set of SRs when the staggering parameter is two.

Example 13 includes the method of examples 1-10 and/or some other example(s) herein, wherein data stored in the shared memory system is staggered by an eighth of a number of SRs in the set of SRs when the staggering parameter is three.

Example 14 includes the method of examples 1-10 and/or some other example(s) herein, wherein data stored in the shared memory system is staggered by a sixteenth of a number of SRs in the set of SRs when the staggering parameter is four.

Example 15 includes the method of examples 1-10 and/or some other example(s) herein, wherein data stored in the shared memory system is staggered by a thirty-second of a number of SRs in the set of SRs when the staggering parameter is five.

Example 16 includes the method of examples 1-15 and/or some other example(s) herein, wherein the access address is received with a request to obtain data from the at least one SR, and the accessing includes: providing the accessed data to the individual access agent.

Example 17 includes the method of examples 1-16 and/or some other example(s) herein, wherein the access address is received with data to be stored in the at least one SR, and the accessing includes: storing the received data in the at least one SR.

Example 18 includes the method of examples 1-17 and/or some other example(s) herein, wherein the shared memory system has a size of two megabytes, the set of SRs includes 32 SRs, and a size of each SR in the set of SRs is 64 kilobytes.

Example 19 includes the method of example 18 and/or some other example(s) herein, wherein the memory transaction is 16 bytes wide.

Example 20 includes the method of examples 1-19 and/or some other example(s) herein, wherein the individual access agent is a data processing unit (DPU) connected to the shared memory system via a set of input delivery unit (IDU) ports and a set of output delivery unit (ODU) ports.

Example 21 includes the method of example 20 and/or some other example(s) herein, wherein the method includes: receiving the access address over the set of ODU ports; and providing the accessed data to the DPU over the set of IDU ports.

Example 22 includes the method of examples 20-21 and/or some other example(s) herein, wherein the set of ODU ports has a first number of ports and the set of IDU ports has a second number of ports, wherein the first number is different than the second number.

Example 23 includes the method of example 22 and/or some other example(s) herein, wherein the first number is four and the second number is eight.

Example 24 includes the method of examples 1-23 and/or some other example(s) herein, wherein the shared memory system and the plurality of access agents are part of a compute tile.

Example 25 includes the method of examples 1-24 and/or some other example(s) herein, wherein the access arbitration circuitry is implemented by an infrastructure processing unit (IPU) configured to support one or more processors connected to the IPU.

Example 26 includes the method of example 25 and/or some other example(s) herein, wherein the IPU is part of an X-processing unit (XPU) arrangement, wherein the XPU arrangement includes one or more processing elements connected to the IPU.

Example 27 includes the method of example 26 and/or some other example(s) herein, wherein the plurality of access agents include the one or more processors connected to the IPU and the one or more processing elements of the XPU.

Example 28 includes the method of examples 1-27 and/or some other example(s) herein, wherein the shared memory system and the plurality of access agents are part of a compute tile.

Example 29 includes the method of examples 1-28 and/or some other example(s) herein, wherein the plurality of access agents include one or more of data processing units (DPUs), streaming hybrid architecture vector engine (SHAVE) processors, central processing units (CPUs), graphics processing units (GPUs), network processing units (NPUs), field programmable gate arrays (FPGAs), application-specific integrated circuits (ASICs), programmable logic controllers (PLCs), and digital signal processors (DSPs).

Example 30 includes the method of examples 1-29 and/or some other example(s) herein, wherein the access arbitration circuitry is implemented by an IPU connected to a plurality of processing devices, and the plurality of processing devices includes one or more of DPUs, SHAVE processors, CPUs, GPUs, NPUs, FPGAs, ASICs, PLCs, and DSPs.

Example 31 includes the method of examples 1-30 and/or some other example(s) herein, wherein the access arbitration circuitry is a memory controller of the shared memory system.

Example 32 includes the method of examples 1-31 and/or some other example(s) herein, wherein the shared memory system is a Neural Network (NN) Connection Matrix (CMX) memory device.

Example 33 includes one or more computer readable media comprising instructions, wherein execution of the instructions by processor circuitry is to cause the processor circuitry to perform the method of examples 1-32 and/or some other example(s) herein. Example 34 includes a computer program comprising the instructions of example 33 and/or some other example(s) herein. Example 35 includes an Application Programming Interface defining functions, methods, variables, data structures, and/or protocols for the computer program of example 33 and/or some other example(s) herein. Example 36 includes an apparatus comprising circuitry loaded with the instructions of example 33 and/or some other example(s) herein. Example 37 includes an apparatus comprising circuitry operable to run the instructions of example 33 and/or some other example(s) herein. Example 38 includes an integrated circuit comprising one or more of the processor circuitry and the one or more computer readable media of example 33 and/or some other example(s) herein. Example 39 includes a computing system comprising the one or more computer readable media and the processor circuitry of example 33 and/or some other example(s) herein. Example 40 includes an apparatus comprising means for executing the instructions of example 33 and/or some other example(s) herein. Example 41 includes a signal generated as a result of executing the instructions of example 33 and/or some other example(s) herein. Example 42 includes a data unit generated as a result of executing the instructions of example 33 and/or some other example(s) herein. Example 43 includes the data unit of example 42 and/or some other example(s) herein, the data unit is a datagram, network packet, data frame, data segment, a Protocol Data Unit (PDU), a Service Data Unit (SDU), a message, or a database object. Example 44 includes a signal encoded with the data unit of example 42 or 43 and/or some other example(s) herein. Example 45 includes an electromagnetic signal carrying the instructions of example 33 and/or some other example(s) herein. Example 46 includes an apparatus comprising means for performing the method of examples 1-32 and/or some other example(s) herein.

### 4. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “establish” or “establishment” at least in some examples refers to (partial or in full) acts, tasks, operations, and/or the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and/or the like, related to initiating, starting, or warming communication or initiating, starting, or warming a relationship between two entities or elements (e.g., establish a session, establish a session, and/or the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and/or the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and/or the like, and/or the fact of the object, data, data unit, and/or the like being received. The term “receipt” at least in some examples refers to an object, data, data unit, and/or the like, being pushed to a device, system, element, and/or the like (e.g., often referred to as a push model), pulled by a device, system, element, and/or the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and/or the like, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value.

The term “metric” at least in some examples refers to a standard definition of a quantity, produced in an assessment of performance and/or reliability of the network, which has an intended utility and is carefully specified to convey the exact meaning of a measured value.

The term “figure of merit” or “FOM” at least in some examples refers to a quantity used to characterize or measure the performance and/or effectiveness of a device, system or method, relative to its alternatives. Additionally or alternatively, the term “figure of merit” or “FOM” at least in some examples refers to one or more characteristics that makes something fit for a specific purpose.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and/or the like, that is under consideration or being considered. The terms “neighbor” and “proximate” (as in, e.g., “proximate device”) at least in some examples refers to an entity, element, device, system, and/or the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period.

The term “identification” at least in some examples refers to a process of recognizing an identity as distinct from other identities in a particular scope or context, which may involve processing identifiers to reference an identity in an identity database.

The term “lightweight” or “lite” at least in some examples refers to an application or computer program designed to use a relatively small amount of resources such as having a relatively small memory footprint, low processor usage, and/or overall low usage of system resources. The term “lightweight protocol” at least in some examples refers to a communication protocol that is characterized by a relatively small overhead. Additionally or alternatively, the term “lightweight protocol” at least in some examples refers to a protocol that provides the same or enhanced services as a standard protocol, but performs faster than standard protocols, has lesser overall size in terms of memory footprint, uses data compression techniques for processing and/or transferring data, drops or eliminates data deemed to be nonessential or unnecessary, and/or uses other mechanisms to reduce overall overheard and/or footprint.

The term “memory address” at least in some examples refers to a reference to a specific memory location, which can be represented as a sequence of digits and/or characters. The term “physical address” at least in some examples refers to a memory location, which may be a particular memory cell or block in main memory and/or primary storage device(s), or a particular register in a memory-mapped I/O device. In some examples, a “physical address” may be represented in the form of a binary number, and in some cases a “physical address” can be referred to as a “binary address” or a “real address”. The term “logical address” or “virtual address” at least in some examples refers to an address at which an item (e.g., a memory cell, storage element, network host, and/or the like) appears to reside from the perspective of an access agent or requestor. For purposes of the present disclosure, the term “memory address” refers to a physical address, a logical address, and/or a virtual address unless the context dictates otherwise.

The term “address space” at least in some examples refers to a range of discrete addresses, where each address in the address space corresponds to a network host, peripheral device, disk sector, a memory cell, and/or other logical or physical entity. The term “virtual address space” or “VAS” at least in some examples refers to the set of ranges of virtual addresses that are made available to an application, process, service, operating system, device, system, or other entity.

The term “virtual memory” or “virtual storage” at least in some examples refers to a memory management technique that provides an abstraction of memory/storage resources that are actually available on a given machine, which creates the illusion to users of a very large (main) memory. Additionally or alternatively, the “virtual memory” or “virtual storage” at least in some examples refers to an address mapping between applications and hardware memory.

The term “pointer” at least in some examples refers to an object that stores a memory address. This can be that of another value located in computer memory, or in some cases, that of memory-mapped computer hardware. In some examples, a pointer references a location in memory, and obtaining the value stored at that location is known as dereferencing the pointer.

The term “pointer swizzling” or “swizzling” at least in some examples refers to the translation, transformation, conversion, of references based on name or position (or offset) into direct pointer references (e.g., memory addresses). Additionally or alternatively, the term “pointer swizzling” or “swizzling” at least in some examples refers to the translation, transformation, conversion, or other replacement of addresses in data blocks/records with corresponding virtual memory addresses when the referenced data block/record resides in memory

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), x-processing unit (XPU), data processing unit (DPU), and/or the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry. It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module. Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical processing element (e.g., CPU, GPU, DPU, XPU, NPU, and so forth), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data. The term “scratchpad memory” or “scratchpad” at least in some examples refers to a relatively high-speed internal memory used for temporary storage of calculations, data, and/or other work in progress.

The term “shared memory” at least in some examples refers to a memory or memory circuitry that can be accessed by multiple access agents, including simultaneous access to the memory or memory circuitry. Additionally or alternatively, the term “shared memory” at least in some examples refers to a block of memory/memory circuitry that can be accessed by several different processing elements (e.g., individual processors in a multi-processor platform, individual processor cores in a processor, and/or the like). In some examples, the memory/memory circuitry used as a shared memory can be a random access memory (RAM) (or variants thereof) or a portion or section of RAM.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “device” at least in some examples refers to a physical entity embedded inside, or attached to, another physical entity in its vicinity, with capabilities to convey digital information from or to that physical entity.

The term “entity” at least in some examples refers to a distinct component of an architecture or device, or information transferred as a payload.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “architecture” at least in some examples refers to a computer architecture or a network architecture. A “computer architecture” is a physical and logical design or arrangement of software and/or hardware elements in a computing system or platform including technology standards for interacts therebetween. A “network architecture” is a physical and logical design or arrangement of software and/or hardware elements in a network including communication protocols, interfaces, and media transmission.

The term “scheduler” at least in some examples refers to an entity or element that assigns resources (e.g., processor time, network links, memory space, and/or the like) to perform tasks.

The term “arbiter” at least in some examples refers to an electronic device, entity, or element that allocates access to shared resources. The term “memory arbiter” at least in some examples refers to an electronic device, entity, or element that is used in a shared memory system to decide, determine, and/or allocate individual access agents will be allowed to access a shared memory for a particular memory cycle.

The term “appliance,” “computer appliance,” or the like, at least in some examples refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and/or the like. Furthermore, the term “user equipment” or “UE” may include any type of wireless/wired device or any computing device including a wireless communications interface. Examples of UEs, client devices, and/or the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “SmartNIC” at least in some examples refers to a network interface controller (NIC), network adapter, or a programmable network adapter card with programmable hardware accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware.

The term “access point” or “AP” at least in some examples refers to an entity that contains one station (STA) and provides access to the distribution services, via the wireless medium (WM) for associated STAs. An AP comprises a STA and a distribution system access function (DSAF).

The term “edge computing” encompasses many implementations of distributed computing that move processing activities and resources (e.g., compute, storage, acceleration resources) towards the “edge” of the network, in an effort to reduce latency and increase throughput for endpoint users (client devices, user equipment, and/or the like). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and/or the like), OSs, virtual machines (VMs), software/applications, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an application, device, system, and/or the like. The term “network resource” or “communication resource” at least in some examples refers to resources that are accessible by computer devices/systems via a communications network. The term “system resources” at least in some examples refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “network function” or “NF” at least in some examples refers to a functional block within a network infrastructure that has one or more external interfaces and a defined functional behavior. The term “network service” or “NS” at least in some examples refers to a composition of Network Function(s) and/or Network Service(s), defined by its functional and behavioral specification(s).

The term “network function virtualization” or “NFV” at least in some examples refers to the principle of separating network functions from the hardware they run on by using virtualization techniques and/or virtualization technologies. The term “virtualized network function” or “VNF” at least in some examples refers to an implementation of an NF that can be deployed on a Network Function Virtualization Infrastructure (NFVI). The term “Network Functions Virtualization Infrastructure Manager” or “NFVI” at least in some examples refers to a totality of all hardware and software components that build up the environment in which VNFs are deployed. The term “Virtualized Infrastructure Manager” or “VIM” at least in some examples refers to a functional block that is responsible for controlling and managing the NFVI compute, storage and network resources, usually within one operator's infrastructure domain.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smart home, smart building and/or smart city technologies), and the like. IoT devices are usually low-power devices without heavy compute or storage capabilities. The term “Edge IoT devices” at least in some examples refers to any kind of IoT devices deployed at a network's edge.

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network.

The term “communication protocol” (either wired or wireless) at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like.

The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and/or the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and/or the like), Generic Access Network (GAN)/Unlicensed Mobile Access (UMA), High Speed Packet Access (HSPA) (and variants thereof such as HSPA Plus (HSPA+), and/or the like), Long Term Evolution (LTE) (and variants thereof such as LTE-Advanced (LTE-A), Evolved UTRA (E-UTRA), LTE Extra, LTE-A Pro, LTE LAA, MuLTEfire, and/or the like), Fifth Generation (5G) or New Radio (NR), and/or the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., IEEE Standard for Air Interface for Broadband Wireless Access Systems, IEEE Std 802.16-2017, pp. 1-2726 (2 Mar. 2018) (“[WiMAX]”) and variants thereof), Mobile Broadband Wireless Access (MBWA)/iBurst (e.g., IEEE 802.20 and variants thereof), and/or the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), and/or the like), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-GSB, ITS-GSC, and/or the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and/or the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and/or the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally or alternatively, the term “link” at least in some examples refers to a connection between two devices through a RAT for the purpose of transmitting and receiving information. Additionally or alternatively, the term “channel” at least in some examples refers to an input channel (or set of features) and/or an output channel (or a feature map) of a neural network and/or another ML/AI model or algorithm.

The term “flow” at least in some examples refers to a sequence of data and/or data units (e.g., datagrams, packets, or the like) from a source entity/element to a destination entity/element. Additionally or alternatively, the terms “flow” or “traffic flow” at least in some examples refer to an artificial and/or logical equivalent to a call, connection, or link. Additionally or alternatively, the terms “flow” or “traffic flow” at least in some examples refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. For purposes of the present disclosure, the terms “traffic flow”, “data flow”, “dataflow”, “packet flow”, “network flow”, and/or “flow” may be used interchangeably even though these terms at least in some examples refers to different concepts. The term “dataflow” or “data flow” at least in some examples refers to the movement of data through a system including software elements, hardware elements, or a combination of both software and hardware elements. Additionally or alternatively, the term “dataflow” or “data flow” at least in some examples refers to a path taken by a set of data from an origination or source to destination that includes all nodes through which the set of data travels.

The term “stream” at least in some examples refers to a sequence of data elements made available over time. At least in some examples, functions that operate on a stream, which may produce another stream, are referred to as “filters,” and can be connected in pipelines, analogously to function composition; filters may operate on one item of a stream at a time, or may base an item of output on multiple items of input, such as a moving average. Additionally or alternatively, the term “stream” or “streaming” at least in some examples refers to a manner of processing in which an object is not represented by a complete logical data structure of nodes occupying memory proportional to a size of that object, but are processed “on the fly” as a sequence of events.

The term “distributed computing” at least in some examples refers to computation resources that are geographically distributed within the vicinity of one or more localized networks' terminations. The term “distributed computations” at least in some examples refers to a model in which components located on networked computers communicate and coordinate their actions by passing messages interacting with each other in order to achieve a common goal.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfil a goal using technology-agnostic protocols (e.g., HTTP or the like). Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g., fine-grained services) and may use lightweight protocols. The term “network service” at least in some examples refers to a composition of Network Function(s) and/or Network Service(s), defined by its functional and behavioral specification.

The term “session” at least in some examples refers to a temporary and interactive information interchange between two or more communicating devices, two or more application instances, between a computer and user, and/or between any two or more entities or elements. Additionally or alternatively, the term “session” at least in some examples refers to a connectivity service or other service that provides or enables the exchange of data between two entities or elements. The term “network session” at least in some examples refers to a session between two or more communicating devices over a network. The term “web session” at least in some examples refers to session between two or more communicating devices over the Internet or some other network. The term “session identifier,” “session ID,” or “session token” at least in some examples refers to a piece of data that is used in network communications to identify a session and/or a series of message exchanges.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS’ at least in some examples refers to a description or measurement of the overall performance of a service (e.g., telephony and/or cellular service, network service, wireless communication/connectivity service, cloud computing service, and/or the like). In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS’ at least in some examples refers to mechanisms that provide traffic-forwarding treatment based on flow-specific traffic classification. In some implementations, the term “Quality of Service” or “QoS” can be used interchangeably with the term “Class of Service” or “CoS”.

The term “network address” at least in some examples refers to an identifier for a node or host in a computer network, and may be a unique identifier across a network and/or may be unique to a locally administered portion of the network. Examples of network addresses include a Closed Access Group Identifier (CAG-ID), Bluetooth hardware device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (Ipv4), IP version 6 (IPv6), and/or the like), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g., as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof. The term “application identifier”, “application ID”, or “app ID” at least in some examples refers to an identifier that can be mapped to a specific application or application instance.

The term “application” at least in some examples refers to a computer program designed to carry out a specific task other than one relating to the operation of the computer itself. Additionally or alternatively, term “application” at least in some examples refers to a complete and deployable package, environment to achieve a certain function in an operational environment.

The term “process” at least in some examples refers to an instance of a computer program that is being executed by one or more threads. In some implementations, a process may be made up of multiple threads of execution that execute instructions concurrently.

The term “thread of execution” or “thread” at least in some examples refers to the smallest sequence of programmed instructions that can be managed independently by a scheduler. The term “lightweight thread” or “light-weight thread” at least in some examples refers to a computer program process and/or a thread that can share address space and resources with one or more other threads, reducing context switching time during execution. In some implementations, term “lightweight thread” or “light-weight thread” can be referred to or used interchangeably with the terms “picothread”, “strand”, “tasklet”, “fiber”, “task”, or “work item” even though these terms may refer to difference concepts. The term “fiber” at least in some examples refers to a lightweight thread that shares address space with other fibers, and uses cooperative multitasking (whereas threads typically use preemptive multitasking).

The term “fence instruction”, “memory barrier”, “memory fence”, or “membar” at least in some examples refers to a barrier instruction that causes a processor or compiler to enforce an ordering constraint on memory operations issued before and/or after the instruction. The term “barrier” or “barrier instruction” at least in some examples refers to a synchronization method for a group of threads or processes in source code wherein any thread/process must stop at a point of the barrier and cannot proceed until all other threads/processes reach the barrier.

The term “instantiate” or “instantiation” at least in some examples refers to the creation of an instance. The term “instance” at least in some examples refers to a concrete occurrence of an object, which may occur, for example, during execution of program code.

The term “context switch” at least in some examples refers to the process of storing the state of a process or thread so that it can be restored to resume execution at a later point.

The term “algorithm” at least in some examples refers to an unambiguous specification of how to solve a problem or a class of problems by performing calculations, input/output operations, data processing, automated reasoning tasks, and/or the like.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. An API may be for a web-based system, operating system, database system, computer hardware, or software library.

The term “reference” at least in some examples refers to data useable to locate other data and may be implemented a variety of ways (e.g., a pointer, an index, a handle, a key, an identifier, a hyperlink, and/or the like).

The term “translation” at least in some examples refers to a process of converting or otherwise changing data from a first form, shape, configuration, structure, arrangement, description, embodiment, or the like into a second form, shape, configuration, structure, arrangement, embodiment, description, or the like. In some examples, “translation” can be or include “transcoding” and/or “transformation”.

The term “transcoding” at least in some examples refers to taking information/data in one format and translating the same information/data into another format in the same sequence. Additionally or alternatively, the term “transcoding” at least in some examples refers to taking the same information, in the same sequence, and packaging the information (e.g., bits or bytes) differently.

The term “transformation” at least in some examples refers to changing data from one format and writing it in another format, keeping the same order, sequence, and/or nesting of data items. Additionally or alternatively, the term “transformation” at least in some examples involves the process of converting data from a first format or structure into a second format or structure, and involves reshaping the data into the second format to conform with a schema or other like specification. In some examples, transformation can include rearranging data items or data objects, which may involve changing the order, sequence, and/or nesting of the data items/objects. Additionally or alternatively, the term “transformation” at least in some examples refers to changing the schema of a data object to another schema.

The term “data buffer” or “buffer” at least in some examples refers to a region of a physical or virtual memory used to temporarily store data, for example, when data is being moved from one storage location or memory space to another storage location or memory space, data being moved between processes within a computer, allowing for timing corrections made to a data stream, reordering received data packets, delaying the transmission of data packets, and the like. At least in some examples, a “data buffer” or “buffer” may implement a queue.

The term “circular buffer”, “circular queue”, “cyclic buffer”, or “ring buffer” at least in some examples refers to a data structure that uses a single fixed-size buffer or other area of memory as if it were connected end-to-end or as if it has a circular or elliptical shape.

The term “queue” at least in some examples refers to a collection of entities (e.g., data, objects, events, and/or the like) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some examples refers to an abstract representation of any entity issuing command requests to a service provider and/or receiving services from a service provider.

The term “requestor” or “access agent” at least in some examples refers to an entity or element accessing, requesting access, or attempting to access a resource including shared resources. Examples of a “requestor” or “access agent” include a process, a task, a workload, a subscriber in a publish and subscribe (pub/sub) data model, a service, an application, a virtualization container and/or OS container, a virtual machine (VM), a hardware subsystem and/or hardware component within a larger system or platform, a computing device, a computing system, and/or any other entity or element. The requests for access sent by a requestor or access agent may be any suitable form of request such as, for example, a format defined by any of the protocols discussed herein.

The term “cache” at least in some examples refers to a hardware and/or software component that stores data so that future requests for that data can be served faster. The term “cache hit” at least in some examples refers to the event of requested data being found in a cache; cache hits are served by reading data from the cache, which is faster than re-computing a result or reading from a slower data store. The term “cache miss” at least in some examples refers to the event of requested data not being found in a cache. The term “lookaside cache” at least in some examples refers to a memory cache that shares the system bus with main memory and other subsystems. The term “inline cache” at least in some examples refers to a memory cache that resides next to a processor and shares the same system bus as other subsystems in the computer system. The term “backside cache” at least in some examples refers to level 2 (L2) memory cache that has a dedicated channel to a processor.

The term “exception” at least in some examples refers to an event that can cause a currently executing program to be suspended. Additionally or alternatively, the term “exception” at least in some examples refers to an exception is an event that typically occurs when an instruction causes an error. Additionally or alternatively, the term “exception” at least in some examples refers to an event or a set of circumstances for which executing code will terminate normal operation. The term “exception” at least in some examples can also be referred to as an “interrupt.”

The term “interrupt” at least in some examples refers to a signal or request to interrupt currently executing code (when permitted) so that events can be processed in a timely manner. If the interrupt is accepted, the processor will suspend its current activities, save its state, and execute an interrupt handler (or an interrupt service routine (ISR)) to deal with the event. The term “masking an interrupt” or “masked interrupt” at least in some examples refers to disabling an interrupt, and the term “unmasking an interrupt” or “unmasked interrupt” at least in some examples refers to enabling an interrupt. In some implementations, a processor may have an internal interrupt mask register to enable or disable specified interrupts.

The term “data unit” at least in some examples refers to a basic transfer unit associated with a packet-switched network; a data unit may be structured to have header and payload sections. The term “data unit” at least in some examples may be synonymous with any of the following terms, even though they may refer to different aspects: “datagram”, a “protocol data unit” or “PDU”, a “service data unit” or “SDU”, “frame”, “packet”, a “network packet”, “segment”, “block”, “cell”, “chunk”, and/or the like. Examples of data units, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), and/or other like data structures.

The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert. The term “hash table” at least in some examples refers to a data structure that implements an associative array and/or a structure that can map keys to values, wherein a hash function is used to compute an index (or a hash code) into an array of buckets (or slots) from which the desired value can be found. During lookup, a key is hashed and the resulting hash indicates where the corresponding value is stored.

The term “operating system” or “OS” at least in some examples refers to system software that manages hardware resources, software resources, and provides common services for computer programs. The term “kernel” at least in some examples refers to a portion of OS code that is resident in memory and facilitates interactions between hardware and software components.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and/or the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and/or the like), Linear Dynamical System (LDS), Switching LDS (SLDS), Optical NNs (ONNs), an NN for reinforcement learning (RL) and/or deep RL (DRL), and/or the like.

The term “convolution” at least in some examples refers to a convolutional operation or a convolutional layer of a CNN. The term “convolutional filter” at least in some examples refers to a matrix having the same rank as an input matrix, but having a smaller shape. In some examples, a convolutional filter can be mixed with an input matrix in order to train weights.

The term “convolutional layer” at least in some examples refers to a layer of a deep neural network (DNN) in which a convolutional filter passes along an input matrix (e.g., a CNN). Additionally or alternatively, the term “convolutional layer” at least in some examples refers to a layer that includes a series of convolutional operations, each acting on a different slice of an input matrix.

The term “convolutional neural network” or “CNN” at least in some examples refers to a neural network including at least one convolutional layer. Additionally or alternatively, the term “convolutional neural network” or “CNN” at least in some examples refers to a DNN designed to process structured arrays of data such as images.

The term “convolutional operation” at least in some examples refers to a mathematical operation on two functions (e.g., ƒ and g) that produces a third function (ƒ*g) that expresses how the shape of one is modified by the other where the term “convolution” may refer to both the result function and to the process of computing it. Additionally or alternatively, term “convolutional” at least in some examples refers to the integral of the product of the two functions after one is reversed and shifted, where the integral is evaluated for all values of shift, producing the convolution function. Additionally or alternatively, term “convolutional” at least in some examples refers to a two-step mathematical operation includes element-wise multiplication of the convolutional filter and a slice of an input matrix (the slice of the input matrix has the same rank and size as the convolutional filter); and (2) summation of all the values in the resulting product matrix.

The term “feature” at least in some examples refers to an individual measureable property, quantifiable property, or characteristic of a phenomenon being observed. Additionally or alternatively, the term “feature” at least in some examples refers to an input variable used in making predictions. At least in some examples, features may be represented using numbers/numerals (e.g., integers), strings, variables, ordinals, real-values, categories, and/or the like. Additionally or alternatively, the term “feature” may be synonymous with the term “input channel” or “output channel” at least in the context of machine learning and/or artificial intelligence.

The term “feature extraction” at least in some examples refers to a process of dimensionality reduction by which an initial set of raw data is reduced to more manageable groups for processing. Additionally or alternatively, the term “feature extraction” at least in some examples refers to retrieving intermediate feature representations calculated by an unsupervised model or a pretrained model for use in another model as an input. Feature extraction is sometimes used as a synonym of “feature engineering.”

The term “feature map” at least in some examples refers to a function that takes feature vectors (or feature tensors) in one space and transforms them into feature vectors (or feature tensors) in another space. Additionally or alternatively, the term “feature map” at least in some examples refers to a function that maps a data vector (or tensor) to feature space. Additionally or alternatively, the term “feature map” at least in some examples refers to a function that applies the output of one filter applied to a previous layer. In some embodiments, the term “feature map” may also be referred to as an “activation map”.

The term “feature vector” at least in some examples, in the context of ML, refers to a set of features and/or a list of feature values representing an example passed into a model. Additionally or alternatively, the term “feature vector” at least in some examples, in the context of ML, refers to a vector that includes a tuple of one or more features.

The term “hidden layer”, in the context of ML and NNs, at least in some examples refers to an internal layer of neurons in an ANN that is not dedicated to input or output. The term “hidden unit” refers to a neuron in a hidden layer in an ANN.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions). ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm at least in some examples refers to different concepts than the term “ML model,” these terms may be used interchangeably for the purposes of the present disclosure. Furthermore, the term “AI/ML application” or the like at least in some examples refers to an application that contains some AI/ML models and application-level descriptions. ML techniques generally fall into the following main types of learning problem categories: supervised learning, unsupervised learning, and reinforcement learning.

The term “matrix” at least in some examples refers to a rectangular array of numbers, symbols, or expressions, arranged in rows and columns, which may be used to represent an object or a property of such an object.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result.

The term “reinforcement learning” or “RL” at least in some examples refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL.

The term “supervised learning” at least in some examples refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

The term “tensor” at least in some examples refers to an object or other data structure represented by an array of components that describe functions relevant to coordinates of a space. Additionally or alternatively, the term “tensor” at least in some examples refers to a generalization of vectors and matrices and/or may be understood to be a multidimensional array. Additionally or alternatively, the term “tensor” at least in some examples refers to an array of numbers arranged on a regular grid with a variable number of axes. At least in some examples, a tensor can be defined as a single point, a collection of isolated points, or a continuum of points in which elements of the tensor are functions of position, and the Tensor forms a “tensor field”. At least in some examples, a vector may be considered as a one dimensional (1D) or first order tensor, and a matrix may be considered as a two dimensional (2D) or second order tensor. Tensor notation may be the same or similar as matrix notation with a capital letter representing the tensor and lowercase letters with subscript integers representing scalar values within the tensor.

The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some examples refers to ML algorithms that develop ML models from incomplete training data, where a portion of the sample input does not include labels.

The term “vector” at least in some examples refers to a one-dimensional array data structure. Additionally or alternatively, the term “vector” at least in some examples refers to a tuple of one or more values called scalars. The terms “sparse vector”, “sparse matrix”, “sparse array”, and “sparse tensor” at least in some examples refer to a vector, matrix, array, or tensor including both non-zero elements and zero elements. The terms “dense vector”, “dense matrix”, “dense array”, and “dense tensor” at least in some examples refer to a vector, matrix, array, or tensor including all non-zero elements. The term “zero value compression vector”, “ZVC vector”, or the like at least in some examples refers to a vector that includes all non-zero elements of a vector in the same order as a sparse vector, but excludes all zero elements.

The term “cycles per instruction” or “CPI” at least in some examples refers to the number of clock cycles required to execute an average instruction. In some examples, the “cycles per instruction” or “CPI” is the reciprocal or the multiplicative inverse of the throughput or instructions per cycle (IPC).

The term “instructions per cycle” or “IPC” at least in some examples refers to the average number of instructions executed during a clock cycle, such as the clock cycle of a processor or controller. In some examples, the “instructions per cycle” or “IPC” is the reciprocal or the multiplicative inverse of the cycles per instruction (CPI).

The term “clock” at least in some examples refers to a physical device that is capable of providing a measurement of the passage of time.

The term “duty cycle” at least in some examples refers to the fraction of one period in which a signal or system is active.

The term “cycles per transaction” or “CPT” at least in some examples refers to the number of clock cycles required to execute an average transaction. In some examples, the “cycles per transaction” or “CPT” is the reciprocal or the multiplicative inverse of the throughput or transactions per cycle (TPC).

The term “transactions per cycle” or “TPC” at least in some examples refers to the average number of transactions executed during a clock cycle or duty cycle. In some examples, the “transactions per cycle” or “TPC” is the reciprocal or the multiplicative inverse of the cycles per transaction (CPT).

The term “transaction” at least in some examples refers to a unit of logic or work performed on or within a memory (sub)system, a database management system, and/or some other system or model. In some examples, an individual “transaction” can involve one or more operations.

The term “transactional memory” at least in some examples refers to a model for controlling concurrent memory accesses to a memory (including shared memory).

The term “data access stride” or “stride” at least in some examples refers to the number of locations in memory between beginnings of successive storage elements, which are measured in a suitable data units such as bytes or the like. In some examples, the term “data access stride” or “stride” may also be referred to as a “unit stride”, an “increment”, “pitch”, or “step size”. Additionally or alternatively, the term “stride” at least in some examples refers to the number of pixels by which the window moves after each operation in a convolutional or a pooling operation of a CNN.

The term “memory access pattern” or “access pattern” at least in some examples refers to a pattern with which a system or program reads and writes data to/from a memory device or location of a memory or storage device. Examples of memory access patterns include sequential, strided, linear, nearest neighbor, spatially coherent, scatter, gather, gather and scatter, and random.

Although many of the previous examples are provided with use of specific cellular/mobile network terminology, including with the use of 4G/5G 3GPP network components (or expected terahertz-based 6G/6G+technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the embodiments discussed herein, and as such, any combination of containers, frames, DFs, DEs, IEs, values, actions, and/or features are possible in various embodiments, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of the present disclosure. The present disclosure, therefore, is not to be taken in a limiting sense, and the scope of various aspects is defined only by the appended claims, along with the full range of equivalents to which such claims are entitled.

1-45. (canceled)

46. A memory controller of a shared memory system that is shared among a plurality of access agents, wherein the shared memory system is arranged into a set of shared resources (SRs), the memory controller comprising:
input/output (I/O) circuitry arranged to:
receive, from an individual access agent of the plurality of access agents, an access address for a memory transaction, wherein the access address is assigned to at least one SR in the set of SRs, and
access data stored in the at least one SR using the SR address; and
control circuitry connected to the I/O circuitry, the control circuitry is arranged to translate the access address into an SR address based on a staggering parameter, wherein the staggering parameter is based on a number of bytes by which individual SR addresses of the set of SRs are staggered in the shared memory system.

47. The memory controller of claim 46, wherein the staggering parameter is an offset by which the individual SR addresses are staggered in the shared memory system.

48. The memory controller of claim 46, wherein the access address includes:
an agent address field, wherein the agent address field includes an agent address value, and the agent address value is a virtual address for the at least one SR in an access agent address space, and
a stagger seed field, wherein the stagger seed field includes an stagger seed value, the stagger seed value is used for the translation.

49. The memory controller of claim 48, wherein the control circuitry is arranged to:
perform a bitwise operation on the agent address value using the stagger seed value to obtain the SR address, wherein the bitwise operation includes:
a binary shift left operation based on a difference between a number of bits of the agent address field and the staggering parameter, or
a binary addition operation to add the stagger seed value to the agent address value; and
insert the SR address into the agent address field.

50. The memory controller of claim 49, wherein the staggering parameter is a number of bits of the stagger seed field or a number of bits of the stagger seed value.

51. The memory controller of claim 46, wherein data stored in the shared memory system is staggered by:
half of a number of SRs in the set of SRs when the staggering parameter is one,
a quarter of a number of SRs in the set of SRs when the staggering parameter is two,
an eighth of a number of SRs in the set of SRs when the staggering parameter is three,
a sixteenth of a number of SRs in the set of SRs when the staggering parameter is four, and
a thirty-second of a number of SRs in the set of SRs when the staggering parameter is five.

52. The memory controller of claim 46, wherein the I/O circuitry is arranged to:
provide the accessed data to the individual access agent when the access address is received with a request to obtain data from the at least one SR; and
cause storage of the received data in the at least one SR when the access address is received with data to be stored in the at least one SR.

53. The memory controller of claim 46, wherein the shared memory system has a size of two megabytes, the set of SRs includes 32 SRs, a size of each SR in the set of SRs is 64 kilobytes, and the memory transaction is 16 bytes wide.

54. The memory controller of claim 46, wherein each access agent of the plurality of access agents is connected to the shared memory system via a set of input delivery unit (IDU) ports and a set of output delivery unit (ODU) ports.

55. The memory controller of claim 54, wherein the set of ODU ports has a first number of ports and the set of IDU ports has a second number of ports, wherein the first number is different than the second number.

56. The memory controller of claim 55, wherein the memory controller is implemented by an infrastructure processing unit (IPU) configured to support one or more processors connected to the IPU.

57. The memory controller of claim 56, wherein the IPU is part of an X-processing unit (XPU) arrangement, and the XPU arrangement also includes one or more processing elements connected to the IPU.

58. The memory controller of claim 57, wherein the plurality of access agents include the one or more processors connected to the IPU and the one or more processing elements of the XPU.

59. The memory controller of claim 58, wherein the plurality of access agents include one or more of data processing units (DPUs), streaming hybrid architecture vector engine (SHAVE) processors, central processing units (CPUs), graphics processing units (GPUs), network processing units (NPUs), field programmable gate arrays (FPGAs), application-specific integrated circuits (ASICs), programmable logic controllers (PLCs), and digital signal processors (DSPs).

60. The memory controller of claim 57, wherein the shared memory system and the plurality of access agents are part of a compute tile.

61. The memory controller of claim 60, wherein the shared memory system is a Neural Network (NN) Connection Matrix (CMX) memory device.

62. One or more non-transitory computer-readable media (NTCRM) comprising instructions, wherein execution of the instructions by a memory controller of a shared memory system is to cause the memory controller to:
receive, from an individual access agent of the plurality of access agents, an access address for a memory transaction, wherein the access address is assigned to at least one SR in the set of SRs;
translate the access address into an SR address based on a staggering parameter, wherein the staggering parameter is based on a number of bytes by which individual SR addresses of the set of SRs are staggered in the shared memory system; and
access data stored in the at least one SR using the SR address.

63. The one or more NTCRM of claim 62, wherein the staggering parameter is an offset by which the individual SR addresses are staggered in the shared memory system.

64. The one or more NTCRM of claim 62, wherein execution of the instructions is to cause the memory controller to:
an agent address field, wherein the agent address field includes an agent address value, and the agent address value is a virtual address for the at least one SR in an access agent address space, and
a stagger seed field, wherein the stagger seed field includes an stagger seed value, the stagger seed value is used for the translation.

65. The one or more NTCRM of claim 64, wherein execution of the instructions is to cause the memory controller to:
perform a bitwise operation on the agent address value using the stagger seed value to obtain the SR address, wherein the bitwise operation includes:
a binary shift left operation based on a difference between a number of bits of the agent address field and the staggering parameter, or
a binary addition operation to add the stagger seed value to the agent address value; and
insert the SR address into the agent address field.

66. The one or more NTCRM of claim 65, wherein the staggering parameter is a number of bits of the stagger seed field or a number of bits of the stagger seed value.

67. The one or more NTCRM of claim 62, wherein data stored in the shared memory system is staggered by:
half of a number of SRs in the set of SRs when the staggering parameter is one,
a quarter of a number of SRs in the set of SRs when the staggering parameter is two,
an eighth of a number of SRs in the set of SRs when the staggering parameter is three,
a sixteenth of a number of SRs in the set of SRs when the staggering parameter is four, and
a thirty-second of a number of SRs in the set of SRs when the staggering parameter is five.

68. The one or more NTCRM of claim 62, wherein execution of the instructions is to cause the memory controller to:
provide the accessed data to the individual access agent when the access address is received with a request to obtain data from the at least one SR; and
cause storage of the received data in the at least one SR when the access address is received with data to be stored in the at least one SR.

69. A shared memory system that is shared among a plurality of processing devices, the shared memory system comprising:
a plurality of shared resources (SRs) configured to store data in a staggered arrangement according to a staggering parameter, wherein the staggering parameter is based on a number of bytes by which individual SR addresses of the plurality of SRs are staggered in the shared memory system; and
a memory controller communicatively coupled with the plurality of processing devices via a set of input delivery unit (IDU) ports and a set of output delivery unit (ODU) ports of each processing device of the plurality of processing devices, and the memory controller is to:
receive, from an individual processing device of the plurality of processing devices, an access address for a memory transaction, wherein the access address is assigned to at least one SR in the plurality of SRs,
translate the access address into an SR address based on the staggering parameter, and
access data stored in the at least one SR using the SR address.

70. The shared memory system of claim 69, wherein the access address includes:
an agent address field, wherein the agent address field includes an agent address value, and the agent address value is a virtual address for the at least one SR in an processing device address space, and
a stagger seed field, wherein the stagger seed field includes an stagger seed value, the stagger seed value is used for the translation, and the staggering parameter is equal to a number of bits of the stagger seed field or a number of bits of the stagger seed value.

71. The shared memory system of claim 69, wherein the memory controller is arranged to:
perform a bitwise operation on the agent address value using the stagger seed value to obtain the SR address, wherein the bitwise operation includes:
a binary shift left operation based on a difference between a number of bits of the agent address field and the staggering parameter, or
a binary addition operation to add the stagger seed value to the agent address value; and
insert the SR address into the agent address field.

72. The shared memory system of claim 69, wherein data stored in the shared memory system is staggered by:
a half of a number of SRs in the plurality of SRs when the staggering parameter is 1,
a quarter of the number of SRs when the staggering parameter is 2,
an eighth of the number of SRs when the staggering parameter is 3,
a sixteenth of the number of SRs when the staggering parameter is 4, and
a thirty-second of the number of SRs when the staggering parameter is 5.

73. The shared memory system of claim 69, wherein:
the plurality of processing devices include data processing units (DPUs) or streaming hybrid architecture vector engine (SHAVE) processors, and
the shared memory system is a Neural Network (NN) Connection Matrix (CMX) memory device.

74. The shared memory system of claim 69, wherein the memory controller is implemented by an infrastructure processing unit (IPU) connected to the plurality of processing devices, and the plurality of processing devices includes one or more of DPUs, SHAVE processors, central processing units (CPUs), graphics processing units (GPUs), network processing units (NPUs), field programmable gate arrays (FPGAs), application-specific integrated circuits (ASICs), programmable logic controllers (PLCs), and digital signal processors (DSPs).

75. The shared memory system of claim 69, wherein the shared memory system and the plurality of processing devices are part of a compute tile, and the compute tile is among a plurality of compute tiles of a vision processing unit (VPU), X-processing unit (XPU), or an IPU.
